(19) United States
(12) Patent Application Publication
(10) Pub. No.: US 2017/0264507 A1
(43) Pub. Date: Sep. 14, 2017

(54) COMMUNICATION METHOD, SYSTEM, AND RECORDING MEDIUM

(71) Applicant: FUJITSU LIMITED, Kawasaki-shi (JP)

(72) Inventor: Masaharu KAKO, Toukai (JP)

(21) Appl. No.: 15/416,677

(22) Filed: Jan. 26, 2017

(30) Foreign Application Priority Data
Mar. 9, 2016 (JP) 2016-046256

(51) Int. Cl. H04L 12/26; H04L 29/08

(52) U.S. Cl. CPC H04L 43/04; H04L 67/10

(57) ABSTRACT

A communication method includes storing, by a communication device, generation log information in which a period of time and an identifier are associated with each other; when another communication device is detected, transmitting, to the another communication device, a combination of a time at which the another communication device is detected and an identifier of the communication device extracted from the generation log information; when a combination of a time at which the communication device is detected and an identifier of the another communication device, is received from the another communication device, storing the combination as reception log information; determining whether an identifier related to the communication device is included in the reception log information stored in a target communication device; and identifying the communication device as a device related to the target communication device when it is determined that the identifier is included in the reception log information.

### CROSS-REFERENCE TO RELATED APPLICATION

This application is based upon and claims the benefit of priority of the prior Japanese Patent Application No. 2016-046256, filed on Mar. 9, 2016, the entire contents of which are incorporated herein by reference.

### FIELD

The embodiments discussed herein are related to a communication method, a system, and a recording medium.

### BACKGROUND

In recent years, contact histories among users have been managed along with spread of mobile body terminals such as a mobile telephone and a smartphone and spread of short-range radio communication. For example, a technique for searching a person infected with a virus or the like or an infection suspected person is known.

For example, a technique is known in which action histories are continuously collected by mobile terminals carried by users and an action history stored in a mobile terminal of a person who is judged as an infected person is disclosed in a hospital. Then, a retrieval person compares an action history stored in a mobile terminal of the retrieval person with the disclosed action history and judges himself/herself as an infection suspected person when accorded information is disclosed.

Further, a technique is known in which short-range communication states among terminals are managed by a server so as to identify an infection suspected person. For example, a mobile terminal performs short-range communication with another nearby mobile terminal so as to acquire an ID of the other mobile terminal and register contact information including an ID thereof, time, and the ID of the other mobile terminal, and the like into a server. The server manages contact information received from each mobile terminal. When an ID of an infected person, infected time, and the like are notified, the server extracts IDs associated with the ID of the infected person from the contact information so as to identify infection suspected persons. As the related art, Japanese Laid-open Patent Publication No. 2011-70248 and Japanese Laid-open Patent Publication No. 2006-311319, for example, are disclosed.

However, in the above-mentioned techniques, information is not concealed and individual information is disclosed, exhibiting low security and being unpractical. For example, an ID for identifying a user is disclosed on a server, so that not only an infected person but also an action history of a user and the like are identified. Considering the above, it is preferable to be possible to determine contact states among users.

### SUMMARY

According to an aspect of the invention, a communication method executed by a system including a plurality of communication devices and a server, the communication method included storing, by a communication device of the plurality of communication devices, generation log information in which a period of time and an identifier varying depending on time are associated with each other for each of a plurality of periods of time; when another communication device among the plurality of communication devices is detected, transmitting, to the another communication device, a combination of a time at which the another communication device is detected and an identifier of the communication device extracted from the generation log information, the identifier corresponding to a time at which the another communication device is detected; when information that includes a combination of a time at which the communication device is detected and an identifier of the another communication device, is received from the another communication device, storing the received information as reception log information; determining whether an identifier related to the communication device is included in the reception log information stored in an target communication device, when the reception log information, which is stored in the target communication device among the plurality of communication devices, is received from the server; and identifying the communication device as a device related to the target communication device when it is determined that the identifier related to the communication device is included in the reception log information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the whole configuration of a system according to the first embodiment;

FIG. 2 illustrates a process from contact to contact confirmation;

FIG. 3 is a functional block diagram illustrating the functional configuration of the system according to the first embodiment;

FIG. 4 illustrates an example of information stored in a random ID generation log;

FIG. 5 illustrates an example of information stored in a proximity person random ID reception log;

FIG. 6 illustrates an example of information stored in an infection suspected person DB;

FIG. 7 is a flowchart illustrating a flow of processing of generating a random ID;

FIG. 8 is a flowchart illustrating a flow of processing of exchanging random IDs;

FIG. 9 is a flowchart illustrating a flow of processing of disclosing infection suspected person information;

FIG. 10 is a flowchart illustrating a flow of processing of determining suspected infection;

FIG. 11 is a sequence diagram illustrating a flow from contact to infection determination;

FIGS. 12A and 12B are sequence diagrams respectively illustrating a flow from contact to infection determination;

FIGS. 13A and 13B respectively illustrates states of random IDs and states of proximity person random IDs of the mobile terminals #A to #E in the period T0 of FIG. 11;

FIGS. 14A and 14B respectively illustrates states of random IDs and states of proximity person random IDs of the mobile terminals #A to #E in the period T1 of FIG. 11;

FIG. 15 illustrates states of random IDs and states of proximity person random IDs of the mobile terminals #C and #D in the period T3 of FIG. 11;

FIG. 16 illustrates states of random IDs and states of proximity person random IDs of the mobile terminals #C and #D in the period T4 of FIG. 11;

FIG. 17 illustrates states of random IDs and states of proximity person random IDs of the mobile terminals #B and #E in the period T5 of FIG. 11;

FIG. 18 illustrates a state of a random ID and states of proximity person random IDs of the mobile terminal #B in the period T7 of FIG. 12A;

FIG. 19 illustrates infection suspected person information of a public server in the period T7 of FIG. 12A;

FIG. 20 illustrates infection determination of the mobile terminal #A in the period T8 of FIG. 12A;

FIG. 21 illustrates infection suspected person information of the public server in the period T9 of FIG. 12A;

FIGS. 22A and 22B respectively illustrates states of random IDs and states of proximity person random IDs of the mobile terminals #C, #D, and #E in the period T9 of FIG. 12A;

FIG. 23 is a flowchart illustrating a flow of processing of disclosing infection suspected person information according to the second embodiment;

FIG. 24 is a flowchart illustrating a flow of processing of determining suspected infection according to the second embodiment;

FIG. 25 illustrates a case where the infection suspected person information of the public server in the period T7 of FIG. 12A is applied to the second embodiment;

FIG. 26 illustrates a case where the infection determination of the mobile terminal #A in the period T8 of FIG. 12A is applied to the second embodiment;

FIG. 27 is a flowchart illustrating a flow of processing of disclosing infection suspected person information according to the third embodiment;

FIG. 28 is a flowchart illustrating a flow of processing of determining suspected infection according to the third embodiment;

FIG. 29 illustrates a case where the infection suspected person information of the public server in the period T7 of FIG. 12A is applied to the third embodiment;

FIG. 30 illustrates a case where the infection determination of the mobile terminal #A in the period T8 of FIG. 12A is applied to the third embodiment;

FIG. 31 illustrates an example in which the infection suspected person information of the public server in the period T7 of FIG. 12A is subjected to grouping;

FIG. 32 illustrates infection determination using grouped infection suspected person information;

FIG. 33 illustrates an example of assigning a sequential number according to the fourth embodiment;

FIG. 34 is a flowchart illustrating a flow of processing of determining suspected infection according to the fourth embodiment;

FIG. 35 illustrates a configuration example of hardware of to mobile terminal;

FIG. 36 illustrates a configuration example of hardware of a public server; and

FIG. 37 illustrates a configuration example of hardware of a terminal device.

### DESCRIPTION OF EMBODIMENTS

Hereinafter, a short-range communication device, a short-range communication method, and a short-range communication program according to embodiments of the present disclosure will be described in detail with reference to the drawings. However, the present disclosure is not limited by these embodiments. The embodiments may be arbitrarily combined within the compatible range.

### First Embodiment

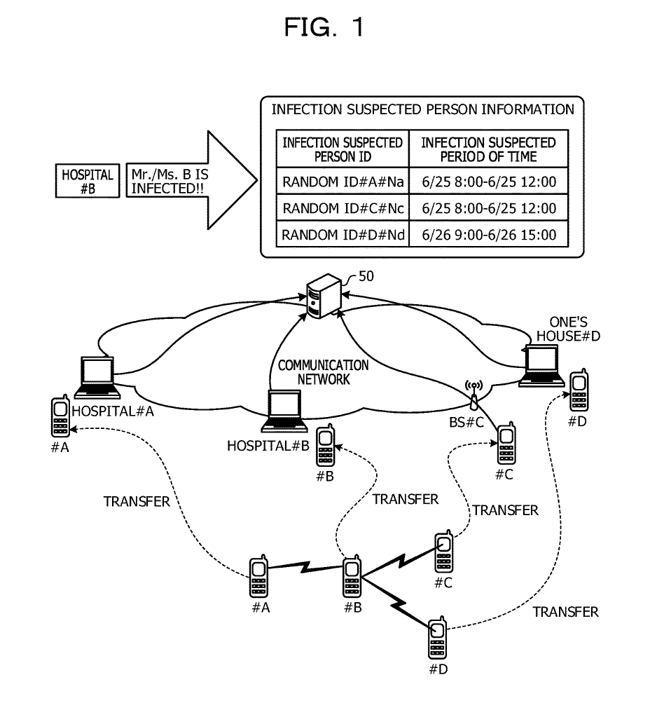

FIG. 1 illustrates an example of the whole configuration of a system according to the first embodiment. As illustrated in FIG. 1, this system is an infected person searching system which includes a mobile terminal #A, a mobile terminal #B, a mobile terminal #C, a mobile terminal #D, a mobile terminal #E, a hospital #A, a hospital #B, a base station (BS) #C, a one's house #D, and a public server 50. These devices are mutually connected by various types of communication.

In this embodiment, devices used by the same user are denoted with an identical “#alphabet”. For example, the mobile terminal #A and the hospital #A are terminals used by a user #A or a user related to the user #A.

These mobile terminals are examples of a mobile body terminal device such as a mobile telephone, a smartphone, and a laptop computer. These mobile terminals are examples of a short-range communication terminal device which executes non-contact short-range communication such as Bluetooth® and near field communication (NFC).

These hospitals are examples of a medical institution terminal installed in a hospital. These hospitals execute radio communication and external connection with each of the mobile terminals. In this embodiment, the hospital #A is sometimes described as the medical institution #A or the medical institution terminal #A, for example. Each base station is a device which executes mobile body communication with the mobile terminal. The one's house #D is a computer used by a user in his/her house. In this embodiment, the one's house #D is sometimes described as the retrieval terminal #D or the retrieval device #D, for example.

The public server 50 is an example of a server device which discloses information which is stored in a mobile terminal of a user, who has developed an infectious disease such as flu, and is used for identifying other mobile terminals. That is, the public server 50 discloses information of an infection suspected person who is possibly infected.

In such system, each mobile terminal stores time information representing time and date or time and a random ID used for identifying the corresponding mobile terminal and varying depending on time information, in a manner to associate the time information with the random ID. When each mobile terminal detects another mobile terminal positioned within a predetermined distance, the mobile terminal transmits a random ID corresponding to time information at the time of detection of the other mobile terminal to the other mobile terminal. Then, in the case where the random ID of the mobile terminal is included in infected person information which is received from another mobile terminal and stored in a mobile terminal used by an infected person, the mobile terminal determines that a user thereof is an infection suspected person.

For example, when the mobile terminal #A approaches the mobile terminal #B, the mobile terminal #A transmits a random ID thereof, which is generated based on time of the approach, to the mobile terminal #B and receives a random ID of the mobile terminal #B from the mobile terminal #B so as to store the random ID of the mobile terminal #B as a proximity person random ID. In a similar manner, when each of the mobile terminal #C and the mobile terminal #D approaches the mobile terminal #B, each of the mobile terminal #C and the mobile terminal #D exchanges random IDs with the mobile terminal #B so as to store the proximity person random ID. The mobile terminal #B receives random IDs of respective mobile terminals #A, #C, and #D so as to store the random IDs as proximity person random IDs.

Then, when the public server 50 receives notification of infection of the user #B from the hospital #B, the public server 50 receives a list of proximity person random IDs stored in the mobile terminal #B from the mobile terminal #B so as to disclose the list as infection suspected person information. Then, in the case where the random IDs of the mobile terminals #A, #C, and #D are included in the disclosed infection suspected person information, the mobile terminals #A, #C, and #D determine users of the mobile terminals #A, #C, and #D as infection suspected persons.

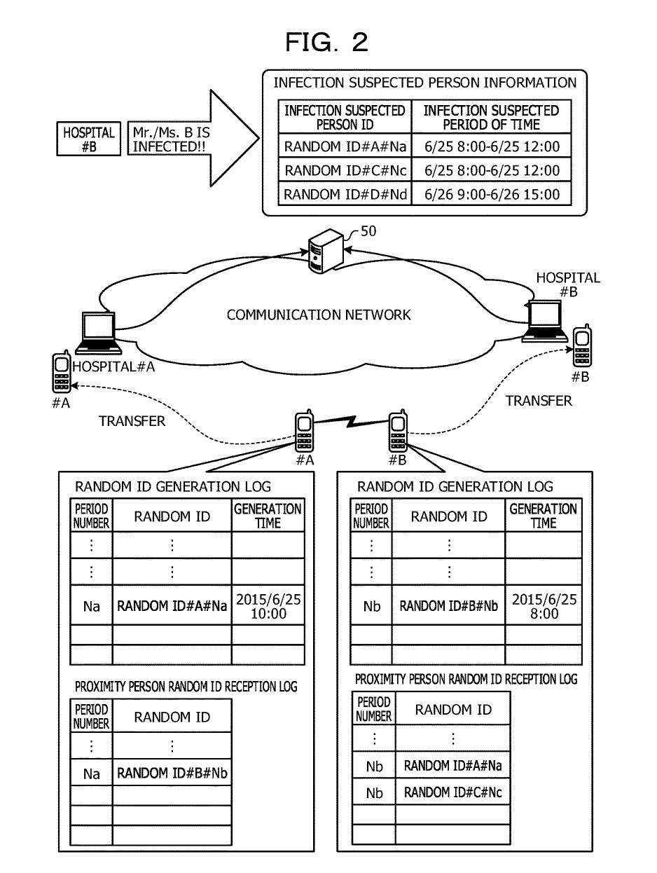

Here, specific description will be provided by taking the mobile terminal #A and the mobile terminal #B as examples. FIG. 2 illustrates a process from contact to contact confirmation. As illustrated in FIG. 2, the mobile terminals #A and #B generate random IDs in each period of time so as to record “period number, random ID, generation time” as a random ID generation log.

For example, in the case where the mobile terminal #B generates a random ID at “2015/6/25, 8:00”, the mobile terminal #B assigns “period number=Nb” associated with “2015/6/25, 8:00” to a random value so as to generate a random ID “random ID #B#Nb”. Subsequently, the mobile terminal #B records “Nb, random ID #B#Nb, 2015/6/25, 8:00”.

In a similar manner, in the case where the mobile terminal #A generates a random ID at “2015/6/25, 10:00”, the mobile terminal #A assigns “period number=Na” associated with “2015/6/25, 10:00” to a random value so as to generate a random ID “random ID #A#Na”. Subsequently, the mobile terminal #A records “Na, random ID #A#Na, 2015/6/25, 10:00”.

When the mobile terminal #A and the mobile terminal #B approach each other in such state, the mobile terminal #A and the mobile terminal #B mutually exchange random IDs thereof corresponding to current time. For example, the mobile terminal #A receives “random ID #B#Nb” from the mobile terminal #B so as to hold the “random ID #B#Nb” as a proximity person random ID. The mobile terminal #B receives “random ID #A#Na” from the mobile terminal #A so as to hold “random ID #A#Na” as a proximity person random ID.

It is assumed that a user of the mobile terminal #B is confirmed as an infected person after that. In this case, the mobile terminal #B registers proximity person random IDs held thereby in the public server 50 and the public server 50 discloses a list of the registered proximity person random IDs as infection suspected person information.

For example, the mobile terminal #B registers infection suspected person information in which proximity person random IDs “random ID #A#Na”, “random ID #C#Nc”, and “random ID #D#Nd”, which are stored in the mobile terminal #B at the time point on which infection is suspected or the time point on which infection is confirmed, are associated with an infection suspected period of time “6/25, 8:00-6/25, 12:00”, which includes an incubation period, in the public server 50 to disclose the infection suspected person information.

Then, the mobile terminal #A accesses the public server 50 through communication via the medical institution terminal #A or communication not via the medical institution terminal #A but by direct connection, at arbitrary timing, so as to acquire the infection suspected person information and determine an infection state of the user #A.

For example, the mobile terminal #A acquires “random ID #A#Na, random ID #C#Nc, random ID #D#Nd, (6/25, 8:00-6/25, 12:00)” as the infection suspected person information. Then, the mobile terminal #A specifies that the random ID “random ID #A#Na” generated and issued by the mobile terminal #A is included in the infection suspected person information. Further, the mobile terminal #A refers to a random ID generation log which is recorded and held in the mobile terminal #A. Then, the mobile terminal #A specifies that a period of time, in which “random ID #A#Na” is generated, is included in the infection suspected period of time “6/25, 8:00-6/25, 12:00”. As a result, the mobile terminal #A determines the user #A as an infection suspected person and displays a determination result on a display unit or the like.

That is, each mobile terminal is capable of determining presence/absence of infection depending on whether or not random IDs managed only in the terminal is included in infection suspected person information. Thus, each mobile terminal is capable of exchanging information in a manner to conceal information for identifying an individual and capable of determining contact states among users.

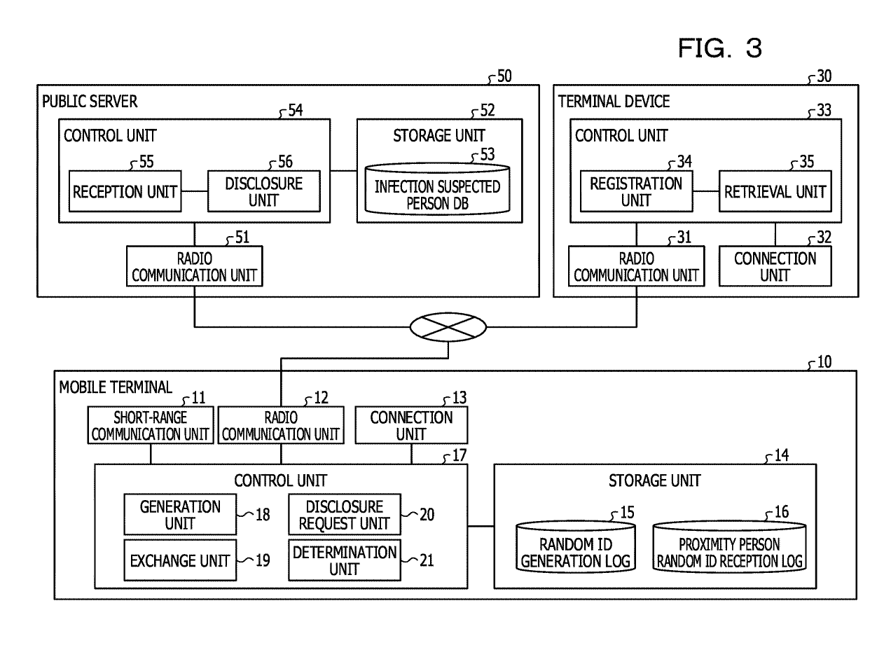

The functional configuration of each device illustrated in FIG. 1 will now be described. FIG. 3 is a functional block diagram illustrating the functional configuration of the system according to the first embodiment. Since the mobile terminals have the similar configurations, description of a mobile terminal 10 will be collectively provided here. Also, since the medical institution terminals and the retrieval terminal have the similar configurations, description of a terminal device 30 will be collectively provided here.

As illustrated in FIG. 3, the mobile terminal 10 includes a short-range communication unit 11, a radio communication unit 12, a connection unit 13, a storage unit 14, and a control unit 17.

The short-range communication unit 11 is a processing unit which executes short-range radio communication such as NFC. For example, when the short-range communication unit 11 detects another mobile terminal in the vicinity thereof such as within 10 m, the short-range communication unit 11 executes exchange of random IDs with the other portable terminal.

The radio communication unit 12 is a processing unit which executes radio communication such as long term evolution (LTE). For example, the radio communication unit 12 controls communication with the public server 50. The radio communication unit 12 registers infection suspected person information in the public server 50 or acquires infection suspected person information from the public server 50.

The connection unit 13 is a processing unit which directly connects with the terminal device 30. For example, the connection unit 13 directly connects with the terminal device 30 with a universal serial bus (USB) or a micro USB, for example, so as to execute exchange of data.

The storage unit 14 is a storage device which stores a program executed by the control unit 17 and data. The storage unit 14 is a memory or a hard disk, for example. The storage unit 14 stores a random ID generation log 15 and a proximity person random ID reception log 16.

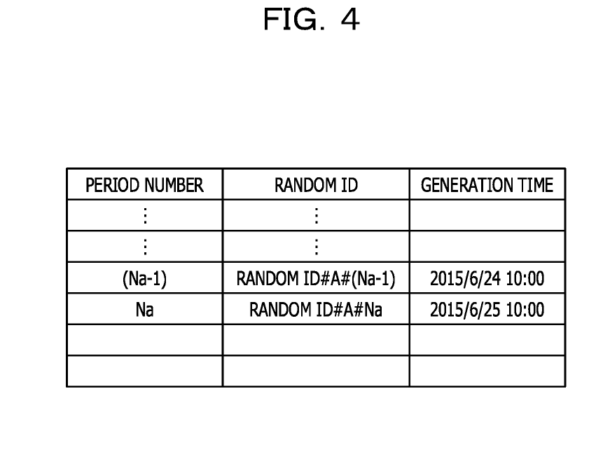

In the random ID generation log 15, a random ID which is used for identifying the mobile terminal 10 and varies depending on time information representing time and date or time is stored. Information stored here is updated by a generation unit 18 which will be described later. FIG. 4 illustrates an example of information stored in the random ID generation log 15. As illustrated in FIG. 4, “period numbers”, “random IDs”, and “generation time” are stored in an associated manner in the random ID generation log 15.

The “period number” stored here is information for identifying a period in which a random ID is used. The “random ID” is an identifier for identifying the mobile terminal 10. The “generation time” is time at which a random ID is generated. FIG. 4 illustrates an example in which the random ID “random ID #A#Na” is generated at “2015/6/25, 10:00” at which the period number “Na” is allocated.

The storage unit 14 stores a “generation interval” which is a cycle for generating a random ID, the “latest generation time” representing the latest time at which a random ID is generated, a “current period number” representing a current period number, and a “current random ID” corresponding to a current period number. For example, the storage unit 14 stores “generation interval=one day”, “latest generation time=2015/6/25, 10:00”, “current period number=Na”, and “current random ID=random ID #A#Na”. The generation interval may be set to arbitrary time such as 1 hour, 3 hours, 12 hours, and time on exchange of random IDs.

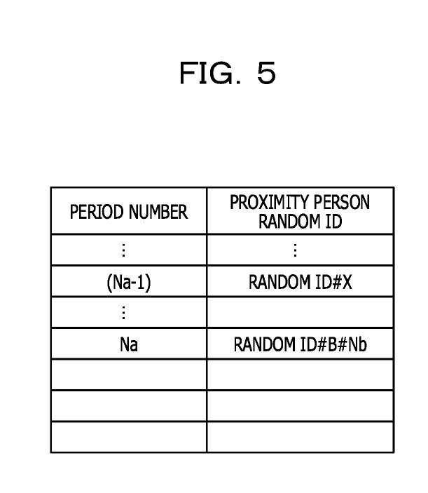

In the proximity person random ID reception log 16, random IDs received from other nearby mobile terminals are stored. Information stored here is updated by an exchange unit 19 which will be described later. FIG. 5 illustrates an example of information stored in the proximity person random ID reception log 16. As illustrated in FIG. 5, “period numbers” and “proximity person random IDs” are stored in an associated manner in the proximity person random ID reception log 16.

The “period number” stored here is a period number which is associated with time at which a random ID is received from another mobile terminal. The “proximity person random ID” is an identifier of another mobile terminal, which is received from the other mobile terminal. FIG. 5 illustrates an example in which the random ID “random ID #B#Nb” is received at “period number=Na”.

The control unit 17 is a processing unit for controlling the whole of the mobile terminal 10 and is a processor, for example. This control unit 17 includes the generation unit 18, the exchange unit 19, a disclosure request unit 20, and a determination unit 21. The generation unit 18, the exchange unit 19, the disclosure request unit 20, and the determination unit 21 are an example of an electronic circuit included in a processor, an example of a process executed by a processor, or the like.

The generation unit 18 is a processing unit which generates a random ID for identifying the mobile terminal 10 in accordance with a generation interval stored in the storage unit 14. Specifically, when the generation interval comes, the generation unit 18 generates a random ID, which varies depending on time information representing time and date or time, and updates a current period number. Subsequently, the generation unit 18 stores the updated period number, the generated random ID, and generation time in the random ID generation log 15 in a manner to associate the period number, the random ID, and the generation time with each other. The generation unit 18 updates the “latest generation time” stored in the storage unit 14 with the generation time and, in a similar manner, updates the “current random ID”.

For example, in the case where the mobile terminal 10 is the mobile terminal #A, the generation unit 18 assigns a “period number” at the time of generation to a random value in accordance with a predetermined rule so as to generate a random ID “random ID #A#period number” which varies depending on time. A random value may be an identifier, an individual number, or the like of the mobile terminal 10 or may be calculated by using a predetermined formula, random numbers, and the like. A position for assigning a period number may be arbitrarily set and may be changed for each period number.

The generation method is not limited to the method described above, but various methods may be employed. For example, the generation unit 18 may assign a hash value calculated by using a predetermined hash function and generation time, a sequence number representing a generation order of generated random IDs, or the like to a random value. The generation methods of random IDs do not have to be synchronized among mobile terminals and may be individually set by each mobile terminal.

The exchange unit 19 is a processing unit which exchanges the latest random IDs when another nearby mobile terminal is detected. Specifically, when another terminal is detected by the short-range communication unit 11, the exchange unit 19 acquires a “current random ID” from the storage unit 14 so as to transmit the current random ID to the other terminal via the short-range communication unit 11. Meanwhile, the exchange unit 19 receives a “current random ID” of the other terminal from the other terminal via the short-range communication unit 11. Then, the exchange unit 19 stores a “current period number” corresponding to reception time and the received “current random ID” in an associated manner in the proximity person random ID reception log 16.

The exchange unit 19 transmits/receives a signal constituted of a “short-range communication header” and a “random ID” to/from another nearby terminal, for example. The “short-range communication header” is a signal header for performing short-range communication. In the “random ID”, the latest random ID at the time of transmission/reception is stored.

The disclosure request unit 20 is a processing unit which requests disclosure of the proximity person random ID reception log 16 from the public server 50 in the case where infection of a user is suspected or the case where infection is confirmed. Specifically, the disclosure request unit 20 generates infection suspected person information constituted of an “infection suspected person random ID” and a “proximity period of time” so as to register the infection suspected person information in the public server 50. Here, the “infection suspected person random ID” is a proximity person random ID received by the mobile terminal 10 of an infected person through short-range communication. The “proximity period of time” is a period corresponding to a current period number at the time when the mobile terminal 10 of the infected person receives the random ID through short-range communication.

For example, the disclosure request unit 20 extracts proximity person random IDs respectively associated with period numbers in an infection suspected period of time including an incubation period, among proximity person random IDs included in the proximity person random ID reception log 16. The disclosure request unit 20 identifies, based on the random ID generation log 15, time and the like in which the period numbers respectively associated with the extracted proximity person random IDs are used. Then, the disclosure request unit 20 registers, in the public server 50, infection suspected person information in which “proximity person random ID=infection suspected person random ID” and “using time=proximity period of time” are associated with each other.

The infection suspected person information does not limitedly include an “infection suspected person random ID” and a “proximity period of time” but may be deformed as various types of information. For example, the disclosure request unit 20 may generate an “infection suspected date”, an “infection suspected person random ID”, and an “infected person random ID” so as to register the “infection suspected date”, the “infection suspected person random ID”, and the “infected person random ID” as infection suspected person information in the public server 50. Here, the “infection suspected date” is a date corresponding to a current period number at the time when the mobile terminal 10 of an infected person has received a proximity person random ID through short-range communication. The “infection suspected person random ID” is a proximity person random ID received by the mobile terminal 10 of the infected person through short-range communication. The “infected person random ID” is a random ID transmitted by the mobile terminal 10 of the infected person through short-range communication.

For example, the disclosure request unit 20 refers to the random ID generation log 15 so as to identify generation time corresponding to an infection suspected period including an incubation period. Subsequently, the disclosure request unit 20 identifies period numbers associated with the identified generation time and further identifies random IDs respectively corresponding to the period numbers. Then, the disclosure request unit 20 refers to the proximity person random ID reception log 16 so as to extract proximity person random IDs respectively associated with the identified period numbers. After that, the disclosure request unit 20 registers, in the public server 50, infection suspected person information including “generation time=infection suspected date (proximity date)”, “proximity person random ID=infection suspected person random ID”, and “random ID=infected person random ID”.

The disclosure request unit 20 may put a check code in the infection suspected person information instead of the above-mentioned “infected person random ID”. This check code is a code generated based on an infection suspected person random ID and an infected person random ID. Specifically, the disclosure request unit 20 may calculate a hash value by using an “infection suspected person random ID” and an “infected person random ID” so as to set the calculated hash value as a check code. An arbitrary function may be employed as a hash function.

Referring back to FIG. 3, the determination unit 21 is a processing unit which determines whether or not to be an infection suspected person by determining whether or not a random ID issued by the device including this determination unit 21 is included in infection suspected person information disclosed by the public server 50.

For example, in the case where a random ID of the device including this determination unit 21 is included in infection suspected person information “infection suspected person random ID, proximity period of time”, the determination unit 21 extracts a “proximity period of time” associated with the random ID of this device in the infection suspected person information. Then, the determination unit 21 refers to the random ID generation log 15 and in the case where generation time of the “random ID” included in the infection suspected person information is included in the “proximity period of time”, the determination unit 21 determines that a user of this device is an infection suspected person.

In the case where infection suspected person information is “infection suspected date, infection suspected person random ID, infected person random ID”, the determination unit 21 further executes the following processing as well as the above-mentioned processing. For example, the determination unit 21 refers to the random ID generation log 15 so as to identify a “period number” associated with the “random ID” included in the infection suspected person information. Then, the determination unit 21 refers to the proximity person random ID reception log 16 so as to extract a “proximity person random ID” associated with the identified “period number”. Subsequently, in the case where a combination of a “random ID” issued by the device including this determination unit 21 and the “proximity person random ID” which has already been received is registered in the infection suspected person information, the determination unit 21 determines that a user of this device is an infection suspected person.

In the case where infection suspected person information is “infection suspected date, infection suspected person random ID, check code”, the determination unit 21 calculates a hash value of the “random ID” issued by the device including this determination unit 21 and the “proximity person random ID” which has been received. Subsequently, in the case where a combination of the “random ID” issued by the device including this determination unit 21 and the “hash value” is registered, the determination unit 21 determines that a user of this device is an infection suspected person.

As illustrated in FIG. 3, the terminal device 30 includes a radio communication unit 31, a connection unit 32, and a control unit 33.

The radio communication unit 31 is a processing unit which executes radio communication such as LTE. For example, the radio communication unit 31 controls communication with the public server 50. The radio communication unit 31 registers infection suspected person information in the public server 50 or acquires infection suspected person information from the public server 50.

The connection unit 32 is a processing unit which directly connects with the mobile terminal 10. For example, the connection unit 32 directly connects with the mobile terminal 10 with a USB or a micro USB, for example, so as to execute exchange of data.

The control unit 33 is a processing unit for controlling the whole of the terminal device 30 and is a processor, for example. This control unit 33 includes a registration unit 34 and a retrieval unit 35. The registration unit 34 and the retrieval unit 35 are an example of an electronic circuit included in a processor, an example of a process executed by a processor, or the like.

The registration unit 34 is a processing unit which registers infection suspected person information generated by the mobile terminal 10 in the public server 50. For example, in the case where the mobile terminal 10 is connected via the connection unit 32, the registration unit 34 receives infection suspected person information transmitted by the mobile terminal 10. Then, the registration unit 34 registers the infection suspected person information in the public server 50 for the mobile terminal 10.

The retrieval unit 35 is a processing unit which accesses the public server 50 to retrieve infection suspected person information. For example, in the case where the mobile terminal 10 is connected via the connection unit 32, the retrieval unit 35 searches and acquires infection suspected person information from the public server 50 by a user operation. Then, the retrieval unit 35 outputs the acquired infection suspected person information to the mobile terminal 10 via the connection unit 32.

As illustrated in FIG. 3, the public server 50 includes a radio communication unit 51, a storage unit 52, and a control unit 54. The radio communication unit 51 is a processing unit which executes radio communication such as LTE. For example, the radio communication unit 51 controls communication with the mobile terminal 10 and the terminal device 30. The radio communication unit 51 receives infection suspected person information from the mobile terminal 10 and the terminal device 30 and transmits infection suspected person information to the mobile terminal 10 and the terminal device 30.

The storage unit 52 is a storage device which stores a program executed by the control unit 54 and data. The storage unit 52 is a memory or a hard disk, for example. The storage unit 52 stores an infection suspected person DB 53. The infection suspected person DB 53 is a database which stores information received from the mobile terminal 10 of an infected person and related to infection suspected persons who are possibly infected.

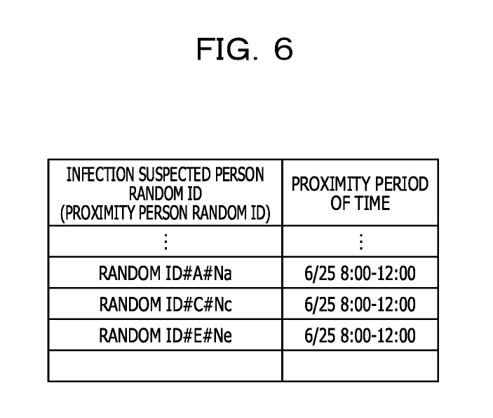

FIG. 6 illustrates an example of information stored in the infection suspected person DB 53. As illustrated in FIG. 6, the infection suspected person DB 53 stores “random ID #A#Na, 6/25, 8:00-12:00”, for example, as “infection suspected person random ID (proximity person random ID), proximity period of time”. In this example, a user, who had contact during “6/25, 8:00-12:00”, of the mobile terminal 10 corresponding to the “random ID #A#Na” is a user who is possibly infected.

The control unit 54 is a processing unit for controlling the whole of the public server 50 and is a processor, for example. This control unit 54 includes a reception unit 55 and a disclosure unit 56. The reception unit 55 and the disclosure unit 56 are an example of an electronic circuit included in a processor, an example of a process executed by a processor, or the like.

The reception unit 55 is a processing unit which receives infection suspected person information from the mobile terminal 10 and the terminal device 30 through radio communication. For example, the reception unit 55 receives infection suspected person information to register the infection suspected person information in the infection suspected person DB 53.

The disclosure unit 56 is a processing unit which reads infection suspected person information stored in the infection suspected person DB 53 so as to disclose the infection suspected person information so that the infection suspected person information is permitted to be browsed by Web browser or the like. Disclosure timing may be arbitrarily set such as regular timing and timing when the infection suspected person DB 53 is updated.

Each processing from generation of a random ID to infection determination executed in the system illustrated in FIG. 1 will now be described. Description will be provided by taking each device illustrated in FIG. 3 as an example here.

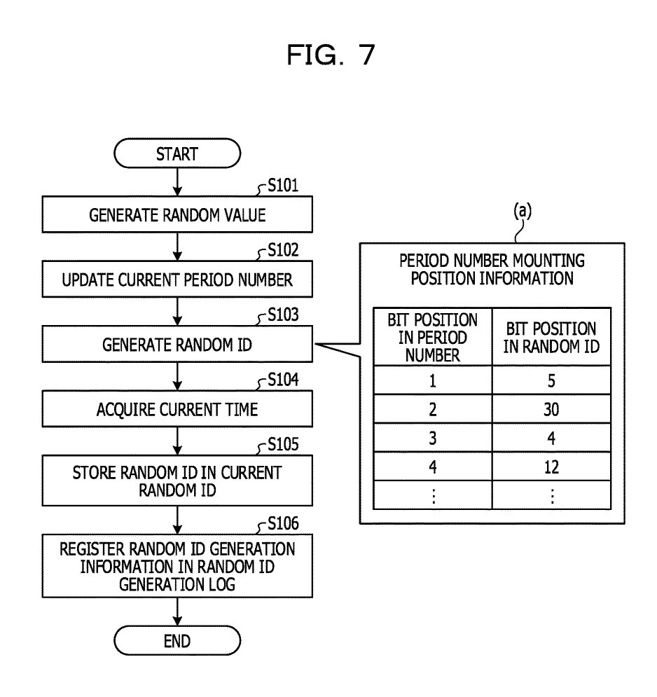

FIG. 7 is a flowchart illustrating a flow of processing of generating a random ID. As illustrated in FIG. 7, the generation unit 18 of the mobile terminal 10 generates a random value (S101) when a generation cycle comes and updates a current period number (S102).

Subsequently, the generation unit 18 generates a random ID in which the current period number is assigned into the random value in accordance with period number mounting position information (S103).

For example, the generation unit 18 holds period number mounting position information in which a “bit position in period number” and a “bit position in random ID” are associated with each other, as illustrated in FIG. 7(a), in the storage unit 14 or the like. The “bit position in period number” is information for identifying an arrangement position in a period number. The “bit position in random ID” is information for identifying an arrangement position of a period number in a random ID. In the case where the whole period number is constituted of two bits, the generation unit 18 refers to FIG. 7(a) so as to assign the first bit in the period number to the fifth bit of a random value. Then, the generation unit 18 generates a random ID in which the second bit in the period number is assigned to the 30th bit of the random value.

Then, the generation unit 18 acquires current time (S104). Subsequently, the generation unit 18 stores the random ID in a current random ID (S105). After that, the generation unit 18 registers the current period number, the current random ID, and the current time in the random ID generation log 15 as a period number, a random ID, and generation time of the random ID generation log 15 respectively (S106).

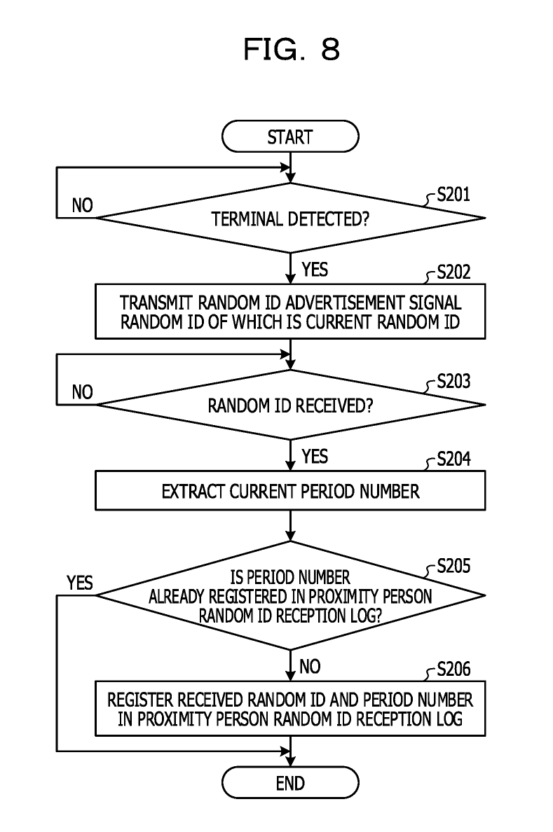

FIG. 8 is a flowchart illustrating a flow of processing of exchanging random IDs. As illustrated in FIG. 8, when the exchange unit 19 of the mobile terminal 10 detects another nearby terminal (S201: Yes), the exchange unit 19 transmits a random ID advertisement signal a random ID of which is a current random ID to the other terminal which is detected (S202).

Then, when the exchange unit 19 receives a random ID from the other nearby terminal (S203: Yes), the exchange unit 19 extracts a current period number (S204). Subsequently, in the case where the period number is already registered in the proximity person random ID reception log 16 (S205: Yes), the exchange unit 19 determines that exchange has been already completed and ends the processing.

On the other hand, in the case where the period number is not registered in the proximity person random ID reception log 16 (S205: No), the exchange unit 19 registers the received random ID and the identified period number in an associated manner in the proximity person random ID reception log 16 (S206).

In FIG. 8, the example in which an own random ID is first transmitted and then a random ID of another terminal is received is described. However, not limited to this, a random ID of another terminal may be first received.

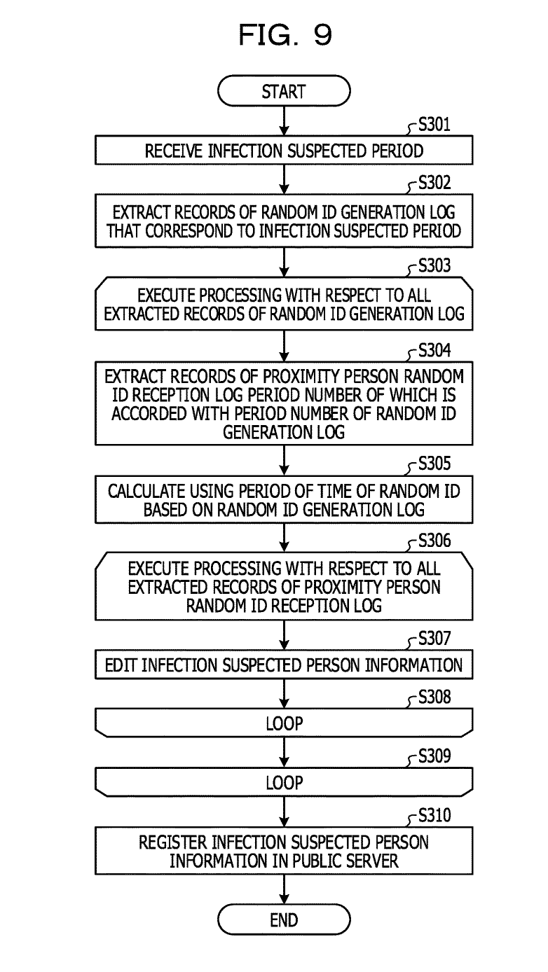

FIG. 9 is a flowchart illustrating a flow of processing of disclosing infection suspected person information. An example in which the mobile terminal 10 executes the processing is described here, but the terminal device 30 is also capable of executing similar processing.

As illustrated in FIG. 9, when the disclosure request unit 20 of the mobile terminal 10 receives an infection suspected period from a user or the like (S301), the disclosure request unit 20 refers to the random ID generation log 15 so as to extract records of the random ID generation log 15 in which generation time corresponds to the infection suspected period (S302).

Then, the disclosure request unit 20 executes loop processing from S303 to S309 with respect to all of the extracted records of the random ID generation log 15. Specifically, the disclosure request unit 20 extracts records of the proximity person random ID reception log 16 a period number of which is accorded with the period number of the random ID generation log 15 (S304). Subsequently, the disclosure request unit 20 calculates a using period of time of a random ID based on the random ID generation log 15 (S305).

After that, the disclosure request unit 20 executes loop processing from S306 to S308 with respect to all of the extracted records of the proximity person random ID reception log 16 (S306). Specifically, the disclosure request unit 20 edits infection suspected person information by using all of the extracted records of the proximity person random ID reception log 16 (S307). For example, the disclosure request unit 20 sets a proximity person random ID and a using period of time of a random ID respectively to an infection suspected person random ID and a proximity period of time in an infection suspected person information list of the public server 50.

Then, after the disclosure request unit 20 executes loop processing from S305 to S308 and the loop processing from S303 to S309, the disclosure request unit 20 registers the infection suspected person information in the infection suspected person DB 53 of the public server 50 (S310).

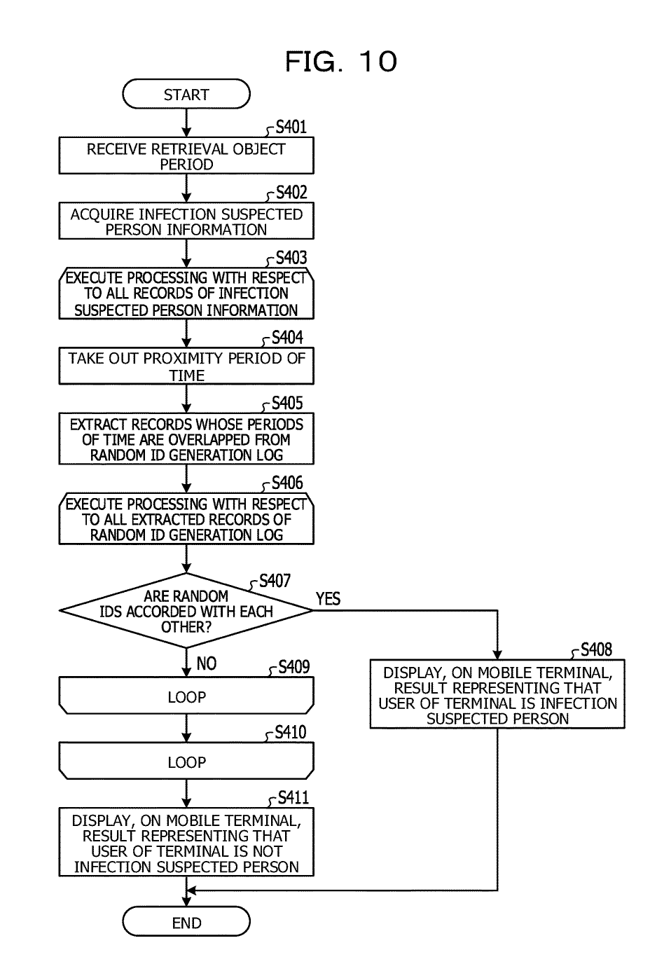

FIG. 10 is a flowchart illustrating a flow of processing of determining suspected infection. As illustrated in FIG. 10, when the determination unit 21 of the mobile terminal 10 receives a retrieval object period in which infection is suspected (S401), the determination unit 21 acquires infection suspected person information in the retrieval object period from the public server 50 (S402).

After that, the determination unit 21 executes loop processing from S403 to S411 with respect to all records of the infection suspected person information (S403). Specifically, the determination unit 21 takes out a proximity period of time from records of the infection suspected person information which are processing objects (S404). Subsequently, the determination unit 21 extracts records whose periods of time are overlapped with the proximity period of time from the random ID generation log 15 (S405). For example, the determination unit 21 extracts records whose using periods of time which correspond to a range from generation time to next generation time in the random ID generation log 15 are accorded with the proximity period of time, among records of the random ID generation log 15.

Subsequently, the determination unit 21 executes loop processing from S406 to S409 with respect to each of the records extracted in S405 (S406). Specifically, the determination unit 21 determines whether or not the random ID of the record extracted in S405 is accorded with the infection suspected person random ID of the record of the infection suspected person information which is a processing object and is selected in S403 (S407). Here, in the case where the random ID is accorded with the infection suspected person random ID (S407: Yes), the determination unit 21 displays, on the mobile terminal 10, a result representing that a user of the device including this determination unit 21 is an infection suspected person (S408). On the other hand, in the case where the random ID is not accorded with the infection suspected person random ID (S407: No), the determination unit 21 executes the loop processing from S406 to S409 with respect to a next record.

After that, when the loop processing from S406 to S409 and the loop processing from S403 to S410 are ended, the determination unit 21 determines that a random ID thereof is not registered in the infection suspected person information. Then, the determination unit 21 displays, on the mobile terminal 10, a result representing that the user of the device including this determination unit 21 is not an infection suspected person (S411).

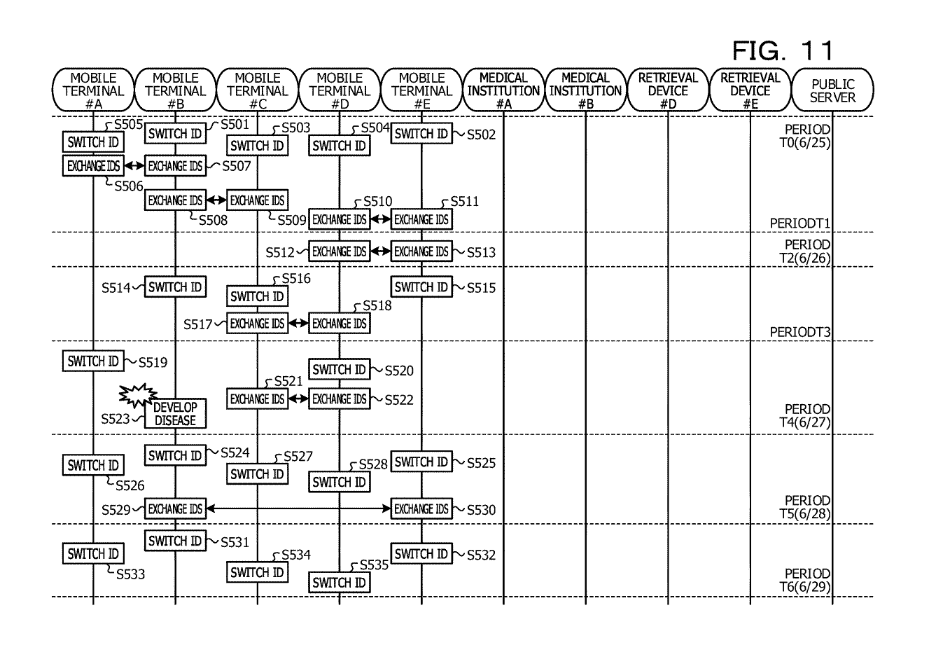

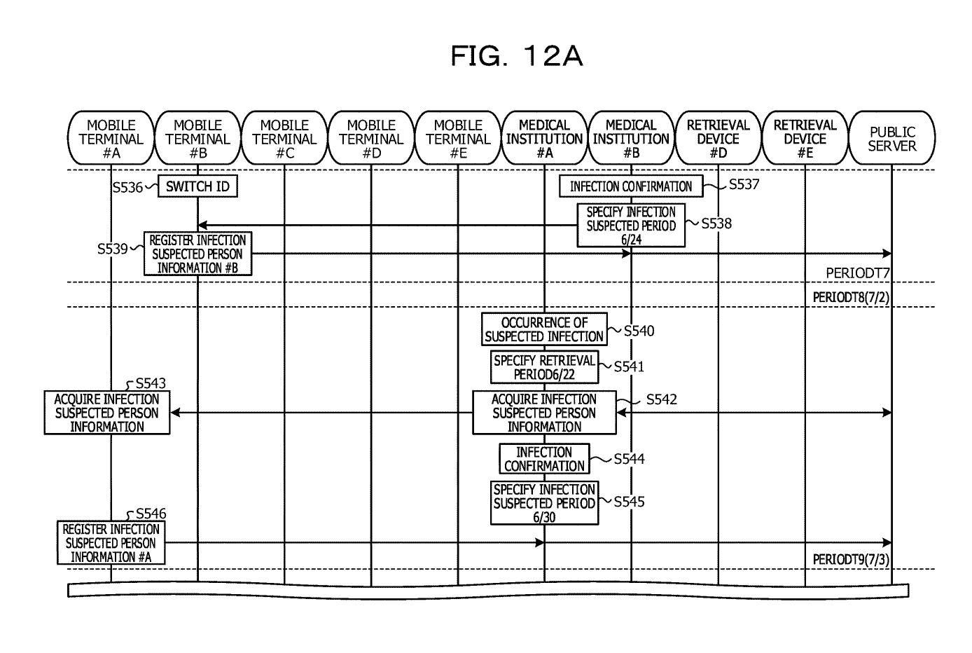

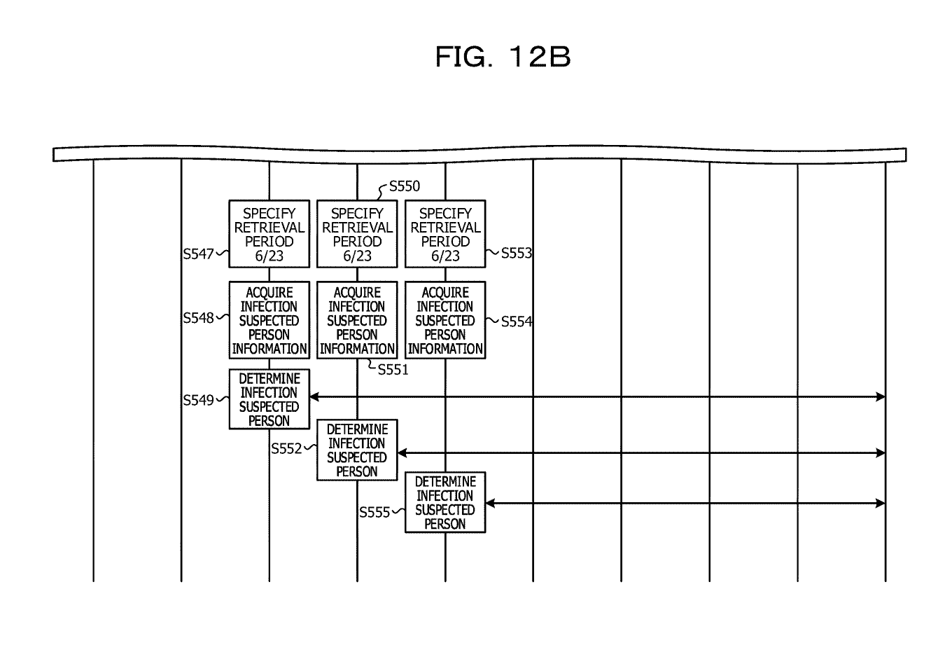

A specific example will now be described with reference to FIGS. 11 to 23. FIG. 11, FIG. 12A and FIG. 12B are sequence diagrams illustrating a flow from contact to infection determination. The description will be provided here by taking five mobile terminals #A to #E as an example. For the sake of convenience of the description, a random ID is described as ID on the drawings.

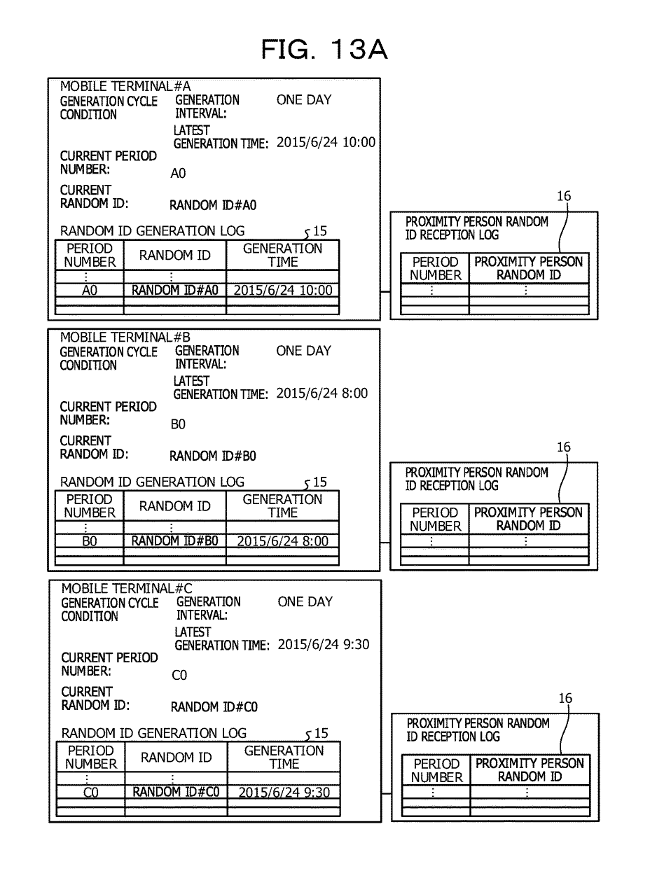

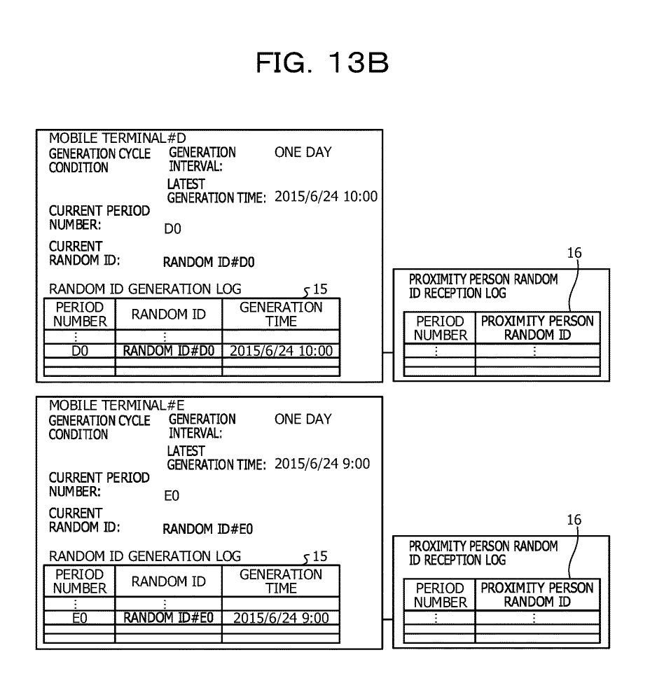

At the time point of period T0 (6/25) illustrated in FIG. 11, exchange of random IDs is not performed yet and each mobile terminal manages only a random ID thereof. FIGS. 13A and 13B respectively illustrates states of random IDs and states of proximity person random IDs of the mobile terminals #A to #E in the period T0 of FIG. 11. In the present embodiment, information of the latest generation time, a current period number, and a current random ID, for example, as well as the random ID generation log 15 are described together so as to make the description easy to understand. It is assumed that a generation interval of a random ID of each terminal is one day.

As illustrated in FIG. 13A, the mobile terminal #A stores “period number=A0, random ID=random ID #A0, generation time (6/24, 10:00)” as the random ID generation log 15. In a similar manner, the mobile terminal #B stores “period number=B0, random ID=random ID #B0, generation time (6/24, 8:00)” as the random ID generation log 15. The mobile terminal #C stores “period number=CO, random ID=random ID #C0, generation time (6/24, 9:30)” as the random ID generation log 15. As illustrated in FIG. 13B, the mobile terminal #D stores “period number=D0, random ID=random ID #D0, generation time (6/24, 10:00)” as the random ID generation log 15. The mobile terminal #E stores “period number=E0, random ID=random ID #E0, generation time (6/24, 9:00)” as the random ID generation log 15.

Referring back to FIG. 11, due to coming of a generation cycle, the mobile terminal #B switches the random ID to the random ID #B1 so as to store the random ID #B1 in the random ID generation log 15 (S501). In a similar manner, the mobile terminal #E switches the random ID to the random ID #E1 so as to store the random ID #E1 in the random ID generation log 15 (S502).

Due to coming of a generation cycle, the mobile terminal #C switches the random ID to the random ID #C1 so as to store the random ID #C1 in the random ID generation log 15 (S503). In a similar manner, the mobile terminal #D switches the random ID to the random ID #D1 so as to store the random ID #D1 in the random ID generation log 15 (S504). Due to coming of a generation cycle, the mobile terminal #A switches the random ID to the random ID #A1 so as to store the random ID #A1 in the random ID generation log 15 (S505).

After that, due to approach between the mobile terminal #A and the mobile terminal #B, the random ID #A1 of the mobile terminal #A and the random ID #B1 of the mobile terminal #B are exchanged with each other (S506 and S507). Further, due to approach between the mobile terminal #B and the mobile terminal #C, the random ID #B1 of the mobile terminal #B and the random ID #C1 of the mobile terminal #C are exchanged with each other (S508 and S509). After that, due to approach between the mobile terminal #D and the mobile terminal #E, the random ID #D1 of the mobile terminal #D and the random ID #E1 of the mobile terminal #E are exchanged with each other (S510 and S511).

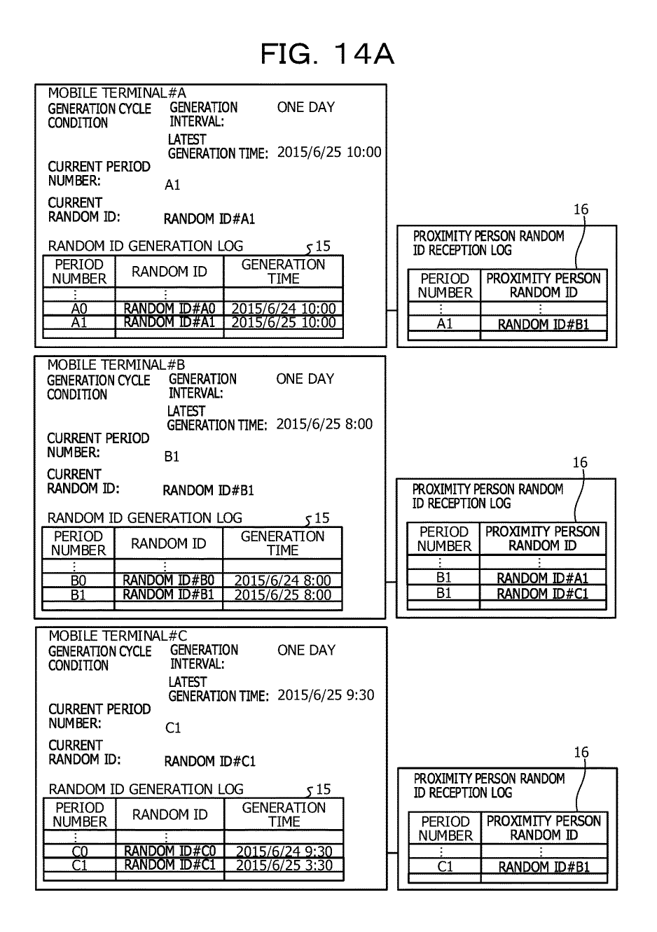

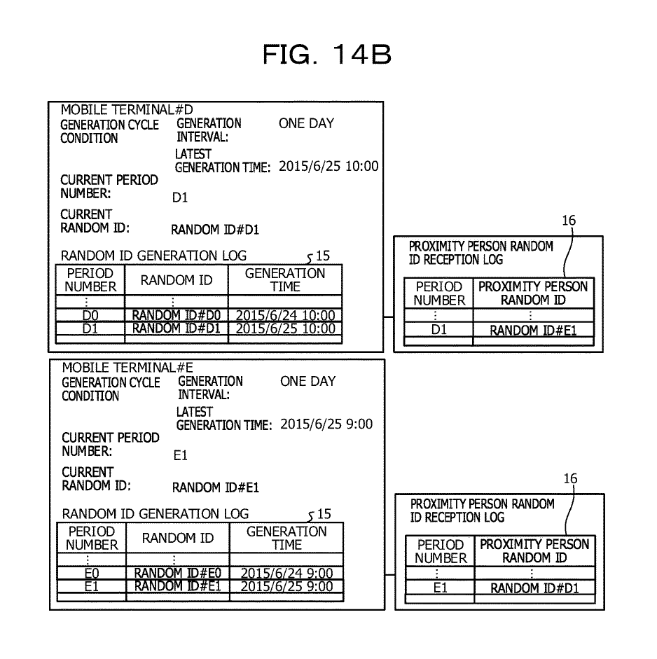

Here, an exchange state of random IDs from the period T0 to the period T1 is described. FIGS. 14A and 14B respectively illustrates states of random IDs and states of proximity person random IDs of the mobile terminals #A to #E in the period T1 of FIG. 11.

As illustrated in FIG. 14A, the mobile terminal #A stores “period number=A1, random ID=random ID #A1, generation time (6/25, 10:00)” as the random ID generation log 15 additionally to the state of the period T0. Then, the mobile terminal #A stores “period number=A1, proximity person random ID=random ID #B1” as the proximity person random ID reception log 16. In a similar manner, the mobile terminal #B additionally stores “period number=B1, random ID=random ID #B1, generation time (6/25, 8:00)” as the random ID generation log 15. Then, the mobile terminal #B stores “period number=B1, proximity person random ID=random ID #A1” and “period number=B1, proximity person random ID=random ID #C1” as the proximity person random ID reception log 16.

The mobile terminal #C additionally stores “period number=C1, random ID=random ID #C1, generation time (6/25, 9:30)” as the random ID generation log 15. Then, the mobile terminal #C stores “period number=C1, proximity person random ID=random ID #B1” as the proximity person random ID reception log 16. The mobile terminal #D additionally stores “period number=D1, random ID=random ID #D1, generation time (6/25, 10:00)” as the random ID generation log 15. Then, the mobile terminal #D stores “period number=D1, proximity person random ID=random ID #E1” as the proximity person random ID reception log 16. The mobile terminal #E additionally stores “period number=E1, random ID=random ID #E1, generation time (6/25, 9:00)” as the random ID generation log 15. Then, the mobile terminal #E stores “period number=E1, proximity person random ID=random ID #D1” as the proximity person random ID reception log 16.

Referring back to FIG. 11, due to second approach between the mobile terminal #D and the mobile terminal #E, the random ID #D1 of the mobile terminal #D and the random ID #E1 of the mobile terminal #E are exchanged with each other (S512 and S513). Here, an exchange state of random IDs to the period T2 (6/26) has not changed from the state of the period T1 (FIG. 14B). Since the mobile terminal #D and the mobile terminal #E merely have exchanged random IDs which are already registered in respective logs without newly switching random IDs, addition is not performed to each log.

Subsequently, due to coming of a generation cycle, the mobile terminal #B switches the random ID to the random ID #B2 so as to store the random ID #B2 in the random ID generation log 15 (S514). Subsequently, the mobile terminal #E switches the random ID to the random ID #E2 so as to store the random ID #E2 in the random ID generation log 15 (S515). The mobile terminal #C switches the random ID to the random ID #C2 so as to store the random ID #C2 in the random ID generation log 15 (S516). After that, due to approach between the mobile terminal #C and the mobile terminal #D, the random ID #C2 of the mobile terminal #C and the random ID #D2 of the mobile terminal #D are exchanged with each other (S517 and S518).

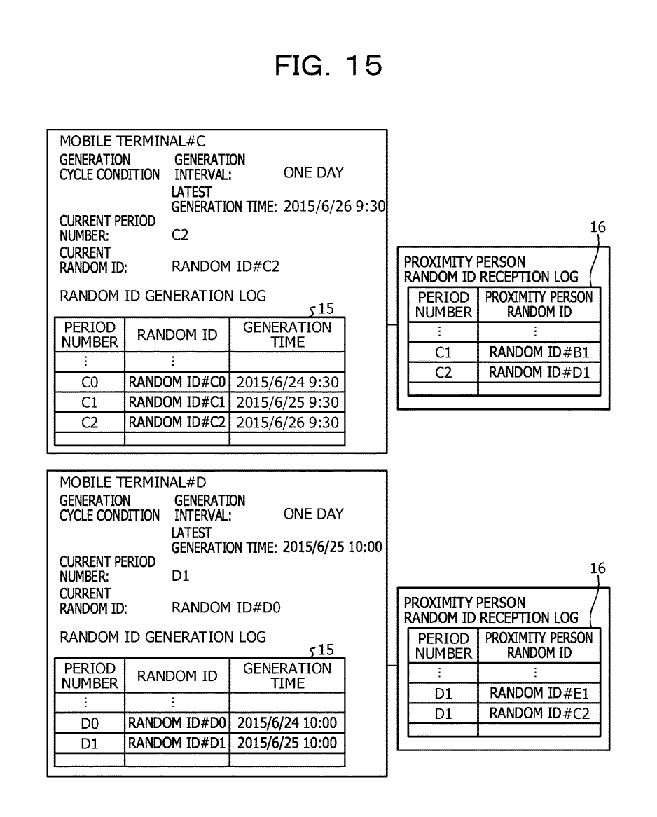

An exchange state of random IDs to the period T3 is described here. FIG. 15 illustrates states of random IDs and states of proximity person random IDs of the mobile terminals #C and #D in the period T3 of FIG. 11.

As illustrated in FIG. 15, the mobile terminal #C stores “period number=C2, random ID=random ID #C2, generation time (6/26, 9:30)” as the random ID generation log 15 additionally to the state of the period T1 (FIG. 14A). Then, the mobile terminal #C additionally stores “period number=C2, proximity person random ID=random ID #D1” as the proximity person random ID reception log 16. In a similar manner, the mobile terminal #D additionally stores “period number=D1, proximity person random ID=random ID #C2” as the proximity person random ID reception log 16 while the random ID generation log 15 does not change. There is no change for other mobile terminals.

Referring back to FIG. 11, due to coming of a generation cycle, the mobile terminal #A switches the random ID to the random ID #A2 so as to store the random ID #A2 in the random ID generation log 15 (S519). Subsequently, due to coming of a generation cycle, the mobile terminal #D switches the random ID to the random ID #D2 so as to store the random ID #D2 in the random ID generation log 15 (S520).

After that, due to approach between the mobile terminal #C and the mobile terminal #D, the random ID #C2 of the mobile terminal #C and the random ID #D2 of the mobile terminal #D are exchanged with each other (S521 and S522). Then, a user of the mobile terminal #B develops a disease (S523).

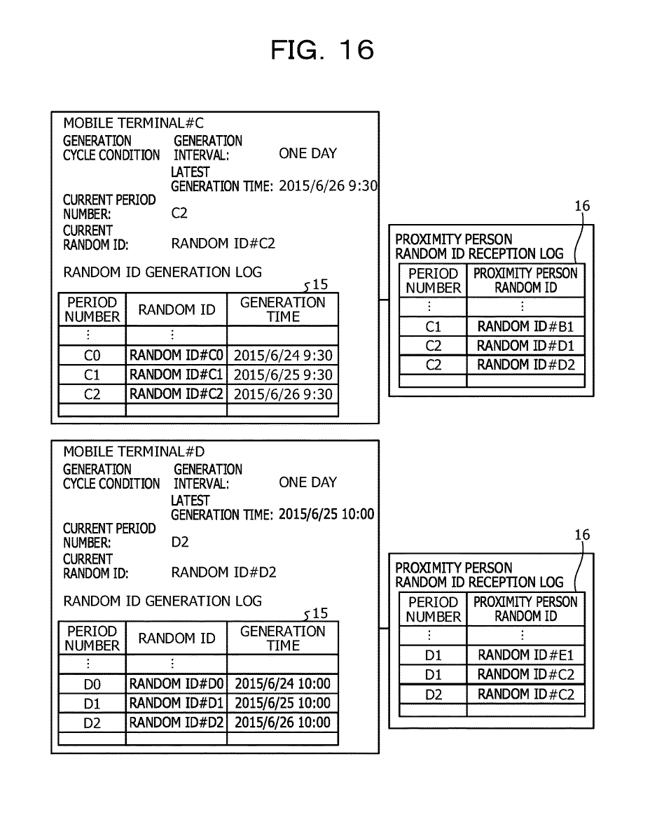

An exchange state of random IDs to the period T4 is described here. FIG. 16 illustrates states of random IDs and states of proximity person random IDs of the mobile terminals #C and #D in the period T4 of FIG. 11.

As illustrated in FIG. 16, there is no change in the random ID generation log 15 from the state of the period T3 (FIG. 15) as for the mobile terminal #C, and the mobile terminal #C additionally stores “period number=C2, proximity person random ID=random ID #D2” as the proximity person random ID reception log 16. In a similar manner, the mobile terminal #D additionally stores “period number=D2, random ID=random ID #D2, generation time (6/26, 10:00)” as the random ID generation log 15. Then, the mobile terminal #D additionally stores “period number=D2, proximity person random ID=random ID #C2” as the proximity person random ID reception log 16. There is no change for other mobile terminals.

Referring back to FIG. 11, due to coming of a generation cycle, the mobile terminal #B switches the random ID to the random ID #B3 so as to store the random ID #B3 in the random ID generation log 15 (S524). In a similar manner, the mobile terminal #E switches the random ID to the random ID #E3 so as to store the random ID #E3 in the random ID generation log 15 (S525). In a similar manner, the mobile terminal #A switches the random ID to the random ID #A3 so as to store the random ID #A3 in the random ID generation log 15 (S526). In a similar manner, the mobile terminal #C switches the random ID to the random ID #C3 so as to store the random ID #C3 in the random ID generation log 15 (S527). In a similar manner, the mobile terminal #D switches the random ID to the random ID #D3 so as to store the random ID #D3 in the random ID generation log 15 (S528).

After that, due to approach between the mobile terminal #B and the mobile terminal #E, the random ID #B3 of the mobile terminal #B and the random ID #E3 of the mobile terminal #E are exchanged with each other (S529 and S530).

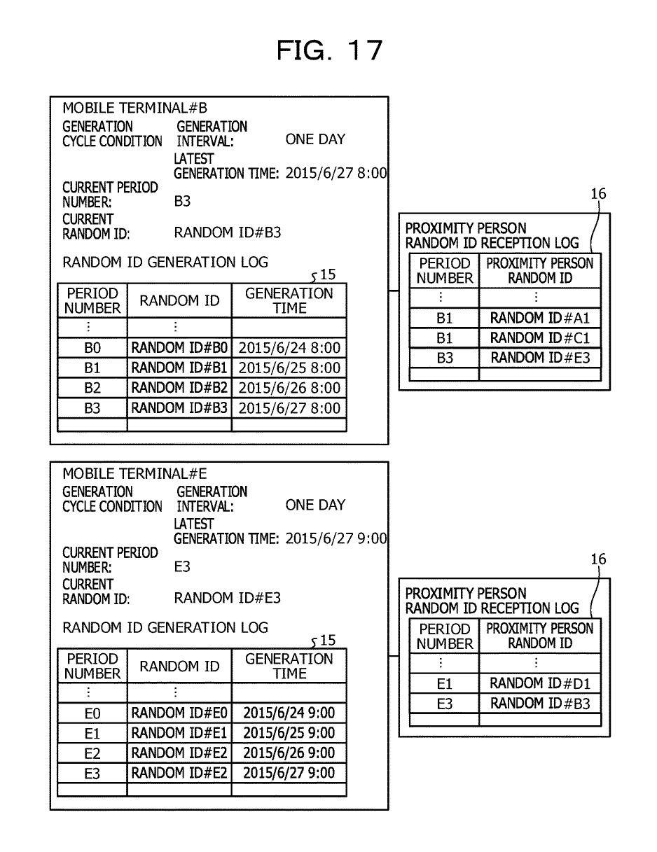

An exchange state of random IDs to the period T5 is described here. FIG. 17 illustrates states of random IDs and states of proximity person random IDs of the mobile terminals #B and #E in the period T5 of FIG. 11.

As illustrated in FIG. 17, the mobile terminal #B additionally stores “period number=B3, random ID=random ID #B3, generation time (6/27, 8:00)” as the random ID generation log 15. Then, the mobile terminal #B additionally stores “period number=B3, proximity person random ID=random ID #E3” as the proximity person random ID reception log 16. In a similar manner, the mobile terminal #E additionally stores “period number=E3, random ID=random ID #E3, generation time (6/27, 9:00)” as the random ID generation log 15. Then, the mobile terminal #E additionally stores “period number=E3, proximity person random ID=random ID #B3” as the proximity person random ID reception log 16. As for other mobile terminals, random IDs of other mobile terminals (#A3, for example) are respectively added as the random ID generation logs 15 to the state of the period T4 and there is no change in the proximity person random ID reception logs 16.

Referring back to FIG. 11, due to coming of a generation cycle, the mobile terminal #B switches the random ID to the random ID #B4 so as to store the random ID #B4 in the random ID generation log 15 (S531). Subsequently, the mobile terminal #E also switches the random ID to the random ID #E4 so as to store the random ID #E4 in a similar manner (S532). The mobile terminal #A also switches the random ID to the random ID #A4 so as to store the random ID #A4 (S533). The mobile terminal #C also switches the random ID to the random ID #C4 so as to store the random ID #C4 in a similar manner (S534). The mobile terminal #D also switches the random ID to the random ID #D4 so as to store the random ID #D4 (S535). At this time point of the period T6, as for other mobile terminals, random IDs of these mobile terminals (#A4, for example) are respectively added as the random ID generation logs 15 and there is no change in the proximity person random ID reception logs 16 from the period T5.

Moving to FIGS. 12A and 12B, due to coming of a generation cycle, the mobile terminal #B switches the random ID to the random ID #B5 so as to store the random ID #B5 in the random ID generation log 15 (S536), as illustrated in FIG. 12A. After that, when infection of the user #B is confirmed in the medical institution #B (S537), the medical institution #B notifies the mobile terminal #B of an infection suspected period (6/24) (S538). The mobile terminal #B registers proximity person random IDs exchanged during the infection suspected period (on and after 6/24) as infection suspected person information in the public server 50 (S539).

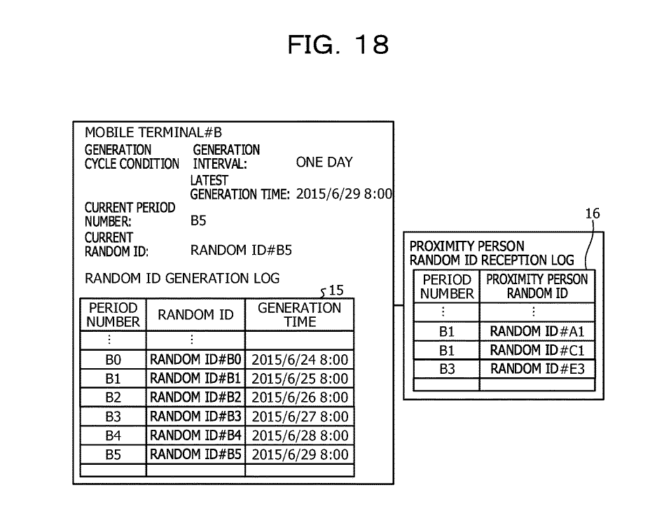

An exchange state of random IDs to the period T7 is described here. FIG. 18 illustrates a state of a random ID and states of proximity person random IDs of the mobile terminal #B in the period T7 of FIG. 12A. As illustrated in FIG. 18, the mobile terminal #B stores “period number=B5, random ID=random ID #B5, generation time (6/29, 8:00)” as the random ID generation log 15 additionally to the state of the period T6. There is no change in the proximity person random ID reception log 16. There is no change in other mobile terminals from the states of the period T6.

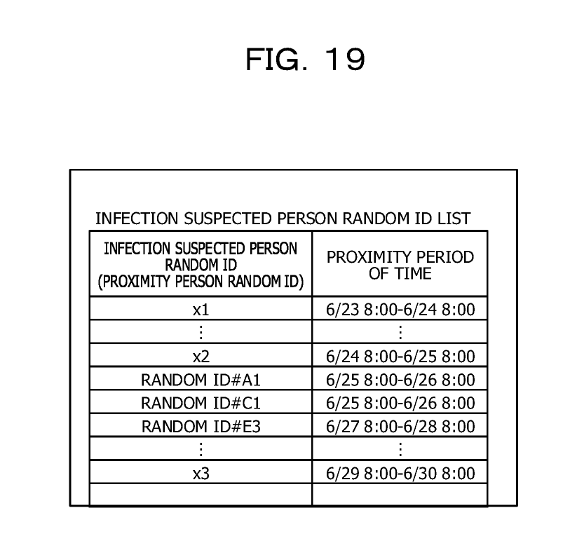

Further, infection suspected person information disclosed in the period T7 is illustrated. FIG. 19 illustrates infection suspected person information of the public server 50 in the period T7 of FIG. 12A. The mobile terminal #B refers to the random ID generation log 15 so as to identify period numbers “from B1 to B5” corresponding to the infection suspected period (on and after 6/24). Then, the mobile terminal #B refers to the proximity person random ID reception log 16 so as to extract “random ID #A1, random ID #C1, random ID #E3” as proximity person random IDs corresponding to these period numbers.

Further, since the period number of the proximity person random ID “random ID #A1” is “B1”, the mobile terminal #B refers to the random ID generation log 15 to identify a used period: from B1 “6/25, 8:00” to B2 “6/26, 8:00”. In a similar manner, since the period number of the proximity person random ID “random ID #C1” is “B1”, the mobile terminal #B refers to the random ID generation log 15 to identify a used period: from B1 “6/25, 8:00” to B2 “6/26, 8:00”. In a similar manner, since the period number of the proximity person random ID “random ID #E3” is “B3”, the mobile terminal #B refers to the random ID generation log 15 to identify a used period: from B3 “6/27, 8:00” to B4 “6/28, 8:00”.

Then, the mobile terminal #B registers the identified proximity person random IDs and used periods (proximity periods of time) in the public server 50. As a result, as illustrated in FIG. 19, “proximity person random ID=random ID #A1, proximity period of time=(6/25, 8:00-6/26, 8:00)”, “proximity person random ID=random ID #C1, proximity period of time=(6/25, 8:00-6/26, 8:00)”, and “proximity person random ID=random ID #E3, proximity period of time=(6/27, 8:00-6/28, 8:00)” are registered in the public server 50.

Referring back to FIGS. 12A and 12B, the medical institution #A subsequently detects an occurrence of suspected infection of the user #A (S540) and specifies a retrieval period (6/22) (S541) so as to acquire infection suspected person information from the public server 50 (S542). That is, the medical institution #A acquires infection suspected person information of 6/22 and after. Then, the mobile terminal #A acquires the infection suspected person information from the medical institution #A (S543) and executes determination of infection suspected persons and infection is determined consequently (S544).

Then, the medical institution #A notifies the mobile terminal #A of the infection suspected period (6/24) (S545). The mobile terminal #A registers the proximity person random IDs exchanged during the infection suspected period (on and after 6/24) as the infection suspected person information in the public server 50 (S546).

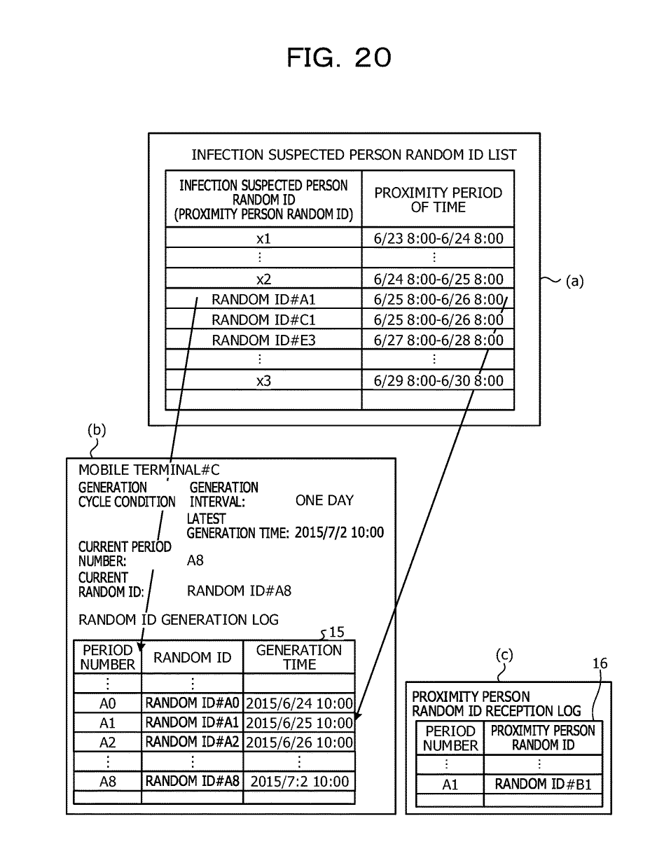

Infection determination of the mobile terminal #A in the period T8 is described here. FIG. 20 illustrates infection determination of the mobile terminal #A in the period T8 of FIG. 12A. As illustrated in FIG. 20, the mobile terminal #A extracts the random ID thereof “random ID #A1” stored in the infection suspected person information (FIG. 20(a)) and the proximity period of time “6/25, 8:00-6/26, 8:00” which corresponds to “random ID #A1” and is stored in the infection suspected person information (FIG. 20(a)). Subsequently, the mobile terminal #A refers to the random ID generation log 15 thereof (FIG. 20(b)) so as to acquire generation time “2015/6/25, 10:00” associated with the random ID “random ID #A1” acquired from the infection suspected person information. Then, since the acquired generation time “2015/6/25, 10:00” is included in the proximity period of time, the mobile terminal #A determines that the user #A is an infection suspected person.

Then, the mobile terminal #A refers to the random ID generation log 15 thereof (FIG. 20(b)) so as to extract the period number “A1” associated with the random ID “random ID #A1” used for the determination of an infection suspected person. Further, the mobile terminal #A refers to the proximity person random ID reception log 16 (FIG. 20(c)) so as to identify the proximity person random ID “random ID #B1” associated with the period number “A1”. Then, the mobile terminal #A registers the proximity person random ID “random ID #B1” and the used period (6/25, 10:00-6/26, 10:00), in which the period number “A1” is used, as the infection suspected person information in the public server 50.

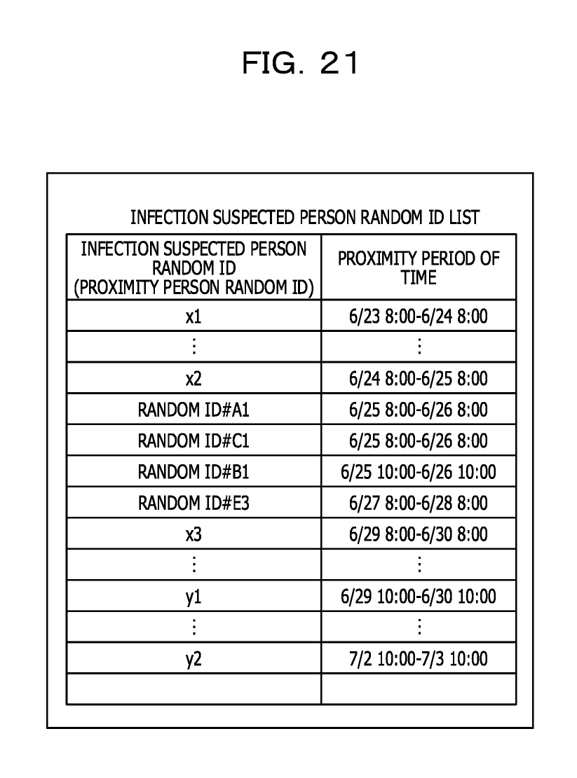

As a result, the infection suspected person information is updated from the one in FIG. 19 to the one in FIG. 21. FIG. 21 illustrates infection suspected person information of the public server 50 in the period T9 of FIG. 12A. As illustrated in FIG. 21, “proximity person random ID=random ID #B1, proximity period of time=(6/25, 10:00-6/26, 10:00)” are newly added to the infection suspected person information, compared to FIG. 19.

Referring back to FIGS. 12A and 12B in such state, the mobile terminal #C specifies a retrieval period (6/23) and acquires the infection suspected person information from the public server 50 so as to execute infection suspected person determination (S547 to S549). The mobile terminal #D specifies a retrieval period (6/23) and acquires the infection suspected person information from the public server 50 so as to execute infection suspected person determination (S550 to S552). The mobile terminal #E specifies a retrieval period (6/23) and acquires the infection suspected person information from the public server 50 so as to execute infection suspected person determination (S553 to S555).

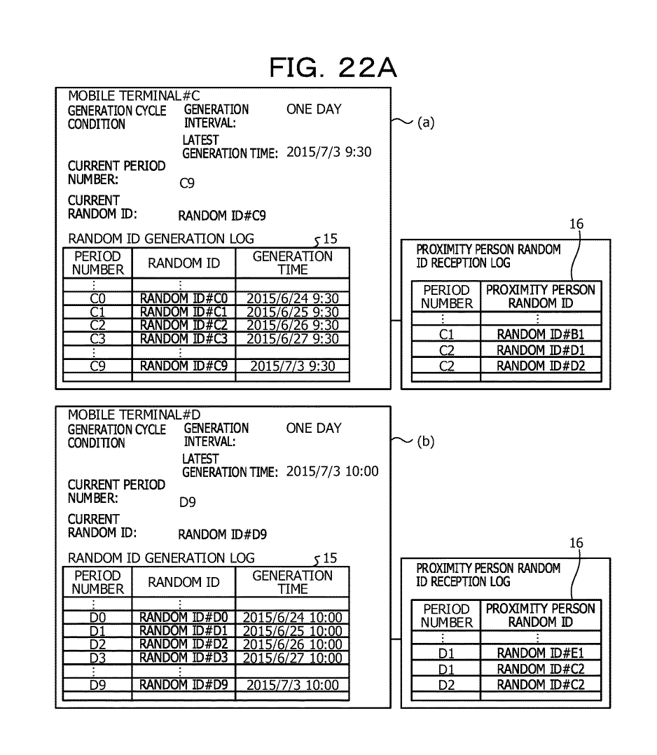

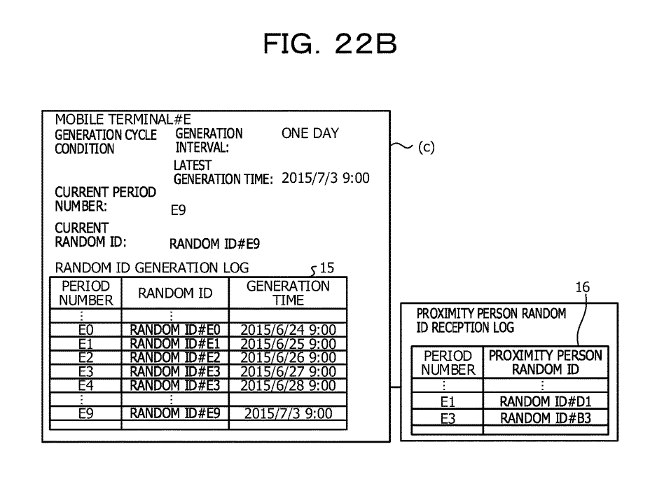

Infection determination of the mobile terminals #C, #D, and #E in the period T9 is described here. FIGS. 22A and 22B respectively illustrates states of random IDs and states of proximity person random IDs of the mobile terminals #C, #D, and #E in the period T9 of FIG. 12A.

As illustrated in (a) of FIG. 22A, since “random ID #C1” issued by the mobile terminal #C is registered in the infection suspected person random ID of FIG. 21 and generation time “2015/6/25, 9:30” of this random ID “random ID #C1” is included in the proximity period of time “6/25, 8:30-6/26, 8:30”, the mobile terminal #C determines that the user #C is an infection suspected person.

As illustrated in (b) of FIG. 22A, since the random ID of the mobile terminal #C is not registered in the infection suspected person random ID of FIG. 21, the mobile terminal #C determines that the user #D is not an infection suspected person.

As illustrated in (c) of FIG. 22B, since “random ID #E3” issued by the mobile terminal #E is registered in the infection suspected person random ID of FIG. 21 and generation time “2015/6/27, 9:00” of this random ID “random ID #E3” is included in the proximity period of time “6/27, 8:00-6/28, 8:00”, the mobile terminal #E determines that the user #E is an infection suspected person.

Thus, in the above-described system, mobile terminals are exchange random IDs respectively managed in these terminals between nearby terminals, permitting only each mobile terminal to determine whether or not a random ID thereof is included in disclosed infection suspected person information. That is, even if a random ID of a mobile terminal is continuously read, moving information of each mobile terminal is fragmented by an operation for generating a random ID by an owner of each mobile terminal, making difficult to grasp actions of the owner. As a result, it is possible to determine contact states among users while concealing identifiers and the like.

It is possible to suppress such state that a person who has developed a disease does not recognize his/her contact with a person infected by a legal communicable disease to spread the infection in a visited hospital and infect other people who come to the hospital in a state in which the disease name is not identified in the consultation at the time of onset. It is possible to determine contact states among users without using positioning facilities such as a global positioning system (GPS) and functions, operation information of public transport system, opening hour and customer gathering state information of facilities, and the like, being able to enhance convenience for users and realize reduction in cost and size of a mobile terminal. Action histories of an infected person, a retrieval person, and the general public do not have to be encrypted, being able to reduce a processing load.

### Second Embodiment

In the first embodiment, the example in which an “infection suspected person random ID (proximity person random ID)” and a “proximity period of time” are disclosed as infection suspected person information is described, but the infection suspected person information is not limited to this. For example, an “infection suspected date (proximity date)”, an “infection suspected person random ID (proximity person random ID)”, and an “infected person random ID” may be disclosed as the infection suspected person information.

Therefore, an example in which an “infection suspected date (proximity date)”, an “infection suspected person random ID (proximity person random ID)”, and an “infected person random ID” are disclosed as infection suspected person information will be described in the second embodiment.

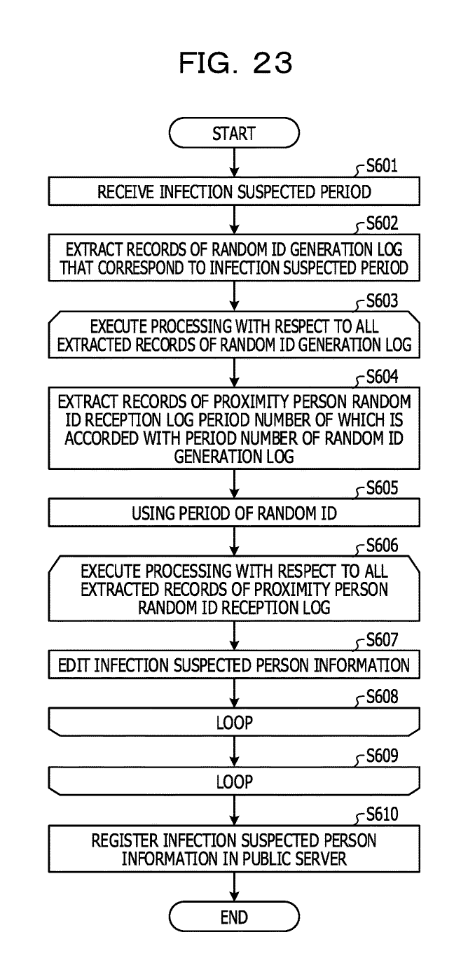

FIG. 23 is a flowchart illustrating a flow of processing of disclosing infection suspected person information according to the second embodiment. As illustrated in FIG. 23, when the disclosure request unit 20 of the mobile terminal 10 receives an infection suspected period from a user or the like (S601), the disclosure request unit 20 refers to the random ID generation log 15 so as to extract records of the random ID generation log 15 in which generation time corresponds to the infection suspected period (S602).

Then, the disclosure request unit 20 executes loop processing from S603 to S609 with respect to all of the extracted records of the random ID generation log 15. Specifically, the disclosure request unit 20 extracts records of the proximity person random ID reception log 16 a period number of which is accorded with the period number of the random ID generation log 15 (S604).

Subsequently, the disclosure request unit 20 calculates a using period of the random ID being selected (in processing) (S605). Specifically, the disclosure request unit 20 identifies “generation time” associated with a period number which is matched between a random ID of the terminal including this disclosure request unit 20 and a proximity person random ID, from the random ID generation log 15. Subsequently, the disclosure request unit 20 identifies “generation time” associated with the next period number of this period number from the random ID generation log 15. Then, the disclosure request unit 20 calculates time between this generation time and the next generation time as a using period of the random ID and sets the date of this using period as an infection suspected date. In the case where the using period is over a plurality of dates, those days are the infection suspected dates.

After that, the disclosure request unit 20 executes loop processing from S606 to S608 with respect to all of the extracted records of the proximity person random ID reception log 16. Specifically, the disclosure request unit 20 edits the infection suspected person information by using all of the extracted records of the proximity person random ID reception log 16 (S607). For example, the disclosure request unit 20 sets an infection suspected date, a proximity person random ID, and a random ID respectively to an infection suspected date, an infection suspected person random ID, and a random ID of an infected person in an infection suspected person information list of the public server 50.

Then, after the disclosure request unit 20 executes loop processing from S605 to S608 and the loop processing from S603 to S609, the disclosure request unit 20 registers the infection suspected person information in the infection suspected person DB 53 of the public server 50 (S610).

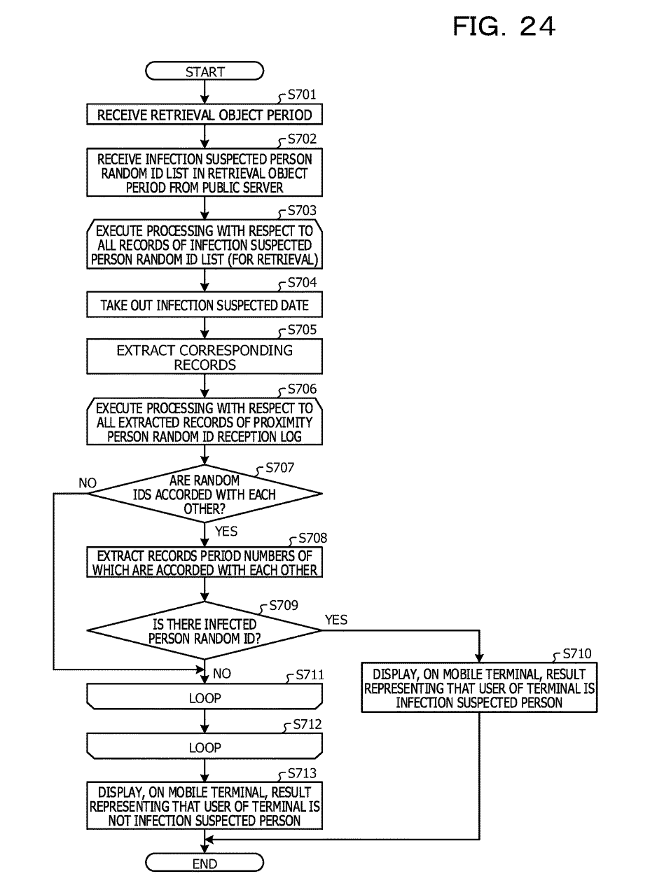

FIG. 24 is a flowchart illustrating a flow of processing of determining suspected infection according to the second embodiment. As illustrated in FIG. 24, when the determination unit 21 of the mobile terminal 10 receives a retrieval object period in which infection is suspected (S701), the determination unit 21 acquires infection suspected person information in the retrieval object period from the public server 50 (S702).

After that, the determination unit 21 executes loop processing from S703 to S712 with respect to all records of the infection suspected person information. Specifically, the determination unit 21 takes out an infection suspected date from records of the infection suspected person information which are processing objects (S704). Subsequently, the determination unit 21 extracts corresponding records from the random ID generation log 15 (S705). For example, the determination unit 21 extracts records whose infection suspected date and using period of time of a random ID are matched, among records of the random ID generation log 15.

Subsequently, the determination unit 21 executes loop processing from S706 to S711 with respect to each of the records extracted in S705. Specifically, the determination unit 21 determines whether or not the random ID of the record extracted in S705 is accorded with the infection suspected person random ID of the record of the infection suspected person information which is a processing object and is selected in S703 (S707). Here, in the case where the random ID is not accorded with the infection suspected person random ID (S707: No), the determination unit 21 executes loop processing from S706 to S711 with respect to the next record.

On the other hand, in the case where the random ID is accorded with the infection suspected person random ID (S707: Yes), the determination unit 21 extracts the proximity person random ID reception logs 16 period numbers of which are accorded with each other (S708). For example, the determination unit 21 extracts records of the proximity person random ID reception logs 16 period numbers of which are accorded with period numbers of the random ID generation logs 15.

After that, in the case where the infected person random ID is in the proximity person random ID reception log 16, in which extraction has been already completed (S709: Yes), the determination unit 21 displays, on the mobile terminal 10, a result representing that a user of the device including this determination unit 21 is an infection suspected person (S710). On the other hand, in the case where the infected person random ID is not in the proximity person random ID reception log 16, which has been extracted (S709: No), the determination unit 21 executes loop processing from S706 to S711 with respect to the next record.

After that, when the loop processing from S706 to S711 and the loop processing from S703 to S712 are ended, the determination unit 21 determines that a random ID thereof is not registered in the infection suspected person information. Then, the determination unit 21 displays, on the mobile terminal 10, a result representing that the user of the device including this determination unit 21 is not an infection suspected person (S713).

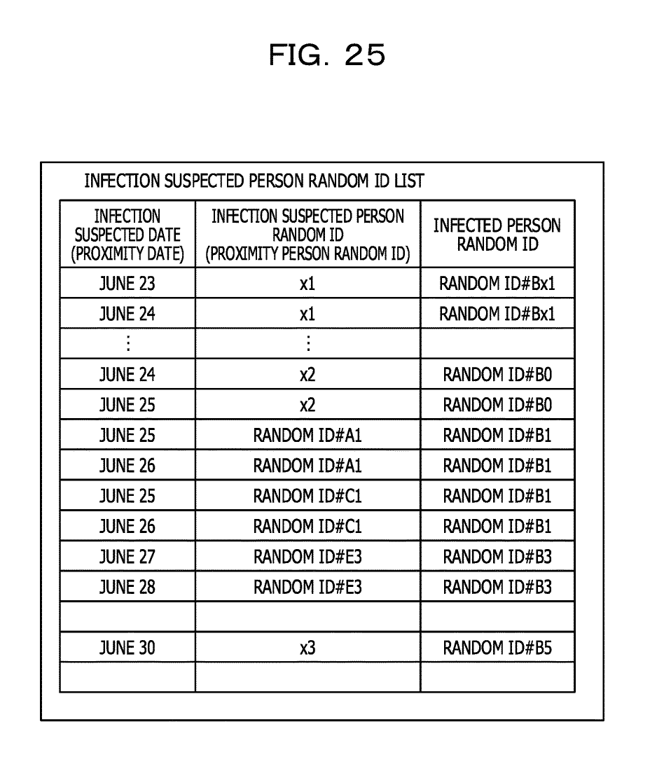

A specific example will now be described with reference to FIG. 11 and the like of the first embodiment. Determination of an infection suspected person which is distinctive processing of the second embodiment will be described here. Specifically, infection suspected person information disclosed in the period T7 will be illustrated. FIG. 25 illustrates a case where the infection suspected person information of the public server 50 in the period T7 of FIG. 12A is applied to the second embodiment.

The mobile terminal #B refers to the random ID generation log 15 so as to identify period numbers “B1 to B5” corresponding to an infection suspected period (on and after 6/24). Then, the mobile terminal #B refers to the proximity person random ID reception log 16 so as to extract “random ID #A1, random ID #C1, random ID #E3” as proximity person random IDs corresponding to these period numbers.

Further, since the period number of the proximity person random ID “random ID #A1” and the proximity person random ID “random ID #C1” is “B1”, the mobile terminal #B refers to the random ID generation log 15 to identify a used period: from B1 “6/25, 8:00” to B2 “6/26, 8:00”. That is, the mobile terminal #B sets infection suspected dates of the proximity person random ID “random ID #A1” and the proximity person random ID “random ID #C1” as “6/25” and “6/26”. Further, the mobile terminal #B identifies the random ID thereof when the period number is “B1” as “random ID #B1”.

In a similar manner, since the period number of the proximity person random ID “random ID #E3” is “B3”, the mobile terminal #B refers to the random ID generation log 15 to identify a used period: from B3 “6/27, 8:00” to B4 “6/28, 8:00”. That is, the mobile terminal #B sets infection suspected dates of the proximity person random ID “random ID #E3” as “6/27” and “6/28”. Further, the mobile terminal #B identifies the random ID thereof when the period number is “B3” as “random ID #B3”.

Then, the mobile terminal #B registers the identified proximity person random IDs, the infection suspected dates, and the infected person random ID in the public server 50. Specifically, as illustrated in FIG. 25, “infection suspected date=6/25, infection suspected person random ID=random ID #A1, infected person random ID=random ID #B1” and “infection suspected date=6/26, infection suspected person random ID=random ID #A1, infected person random ID=random ID #B1” are registered in the public server 50.

In a similar manner, “infection suspected date=6/25, infection suspected person random ID=random ID #C1, infected person random ID=random ID #B1” and “infection suspected date=6/26, infection suspected person random ID=random ID #C1, infected person random ID=random ID #B1” are registered in the public server 50.

In a similar manner, “infection suspected date=6/27, infection suspected person random ID=random ID #E3, infected person random ID=random ID #B3” and “infection suspected date=6/28, infection suspected person random ID=random ID #E3, infected person random ID=random ID #B3” are registered in the public server 50.

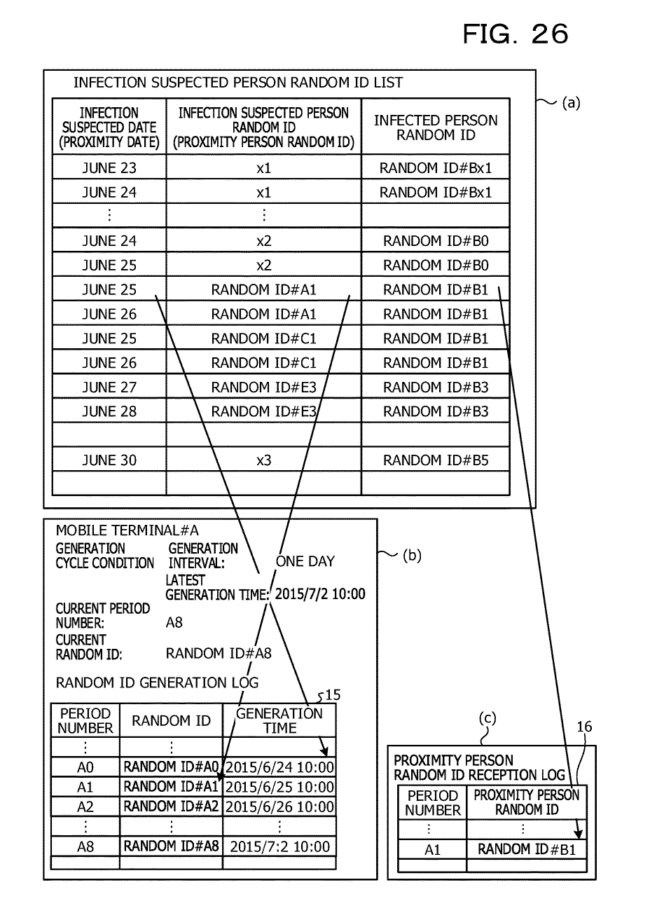

Subsequently, the mobile terminal #A executes infection determination in the period T8. FIG. 26 illustrates a case where the infection determination of the mobile terminal #A in the period T8 of FIG. 12A is applied to the second embodiment. As illustrated in FIG. 26, the mobile terminal #A extracts a random ID thereof “random ID #A1” stored in infection suspected person information (FIG. 26(a)), and an infection suspected date “6/25” and an infected person random ID “random ID #B1” which correspond to the “random ID #A1” and are stored in infection suspected person information (FIG. 26(a)).

Subsequently, the mobile terminal #A refers to the random ID generation log 15 thereof (FIG. 26(b)). Then, the mobile terminal #A acquires generation time “2015/6/25, 10:00” which is associated with the random ID “random ID #A1” acquired from the infection suspected person information. Then, the mobile terminal #A determines that the acquired generation time “2015/6/25, 10:00” is included in the infection suspected date “6/25”.

Further, the mobile terminal #A refers to the random ID generation log 15 thereof (FIG. 26(b)). Then, the mobile terminal #A acquires the period number “A1” which is associated with the random ID “random ID #A1” acquired from the infection suspected person information. The mobile terminal #A refers to the proximity person random ID reception log 16 thereof (FIG. 26(c)). Then, the mobile terminal #A extracts the proximity person random ID “random ID #B1” which is associated with the acquired period number “A1”.

Then, the mobile terminal #A determines that the infected person random ID acquired from the infection suspected person information (FIG. 26(a)) is accorded with the infected person random ID acquired from the proximity person random ID reception log 16 thereof (FIG. 26(c)). As a result, the mobile terminal #A determines that the user #A is an infection suspected person.

Thus, it is possible to identify proximity states among users without using proximity periods of time, being able to omit disclosure of action histories of users and enhance confidentiality of disclosed information.

### Third Embodiment

In the second embodiment, the example in which an “infection suspected date (proximity date)”, an “infection suspected person random ID (proximity person random ID)”, and an “infected person random ID” are disclosed as infection suspected person information is described, but the infection suspected person information is not limited to this. For example, a “check code” may be disclosed instead of an “infected person random ID” so as to be able to further enhance confidentiality.

Therefore, an example in which an “infection suspected date (proximity date)”, an “infection suspected person random ID (proximity person random ID)”, and a “check code” are disclosed as infection suspected person information will be described in the third embodiment.

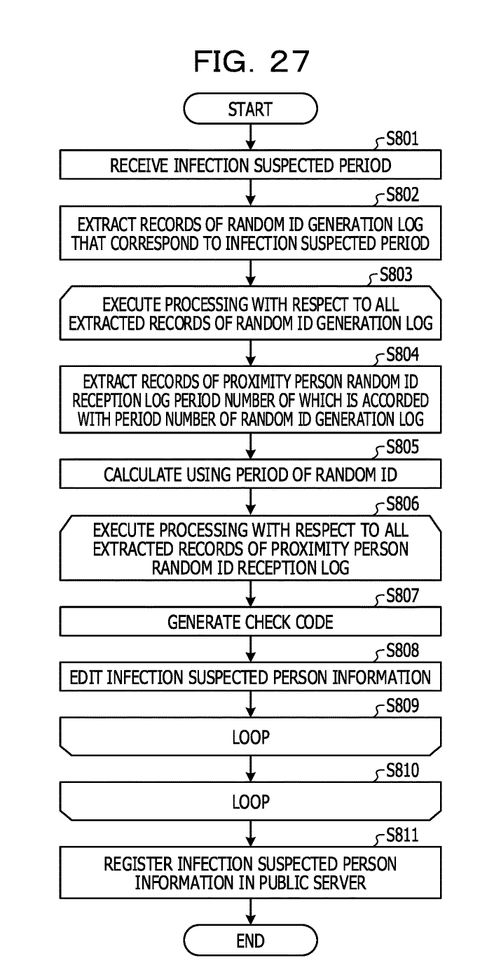

FIG. 27 is a flowchart illustrating a flow of processing of disclosing infection suspected person information according to the third embodiment. The processing illustrated in FIG. 27 is different from that of FIG. 23 in that S807 and S808 are executed instead of S607 illustrated in FIG. 23, compared to FIG. 23. Therefore, only different points will be described.

In S807 of FIG. 27, the disclosure request unit 20 of the mobile terminal 10 generates a check code=Hash (a proximity person random ID, a random ID) by using random IDs and proximity person random IDs. Then, in S808, the disclosure request unit 20 registers an infection suspected date, a proximity person random ID, and a check code in the public server 50 as an infection suspected date, an infection suspected person random ID, and a check code of infection suspected person information of the public server 50.

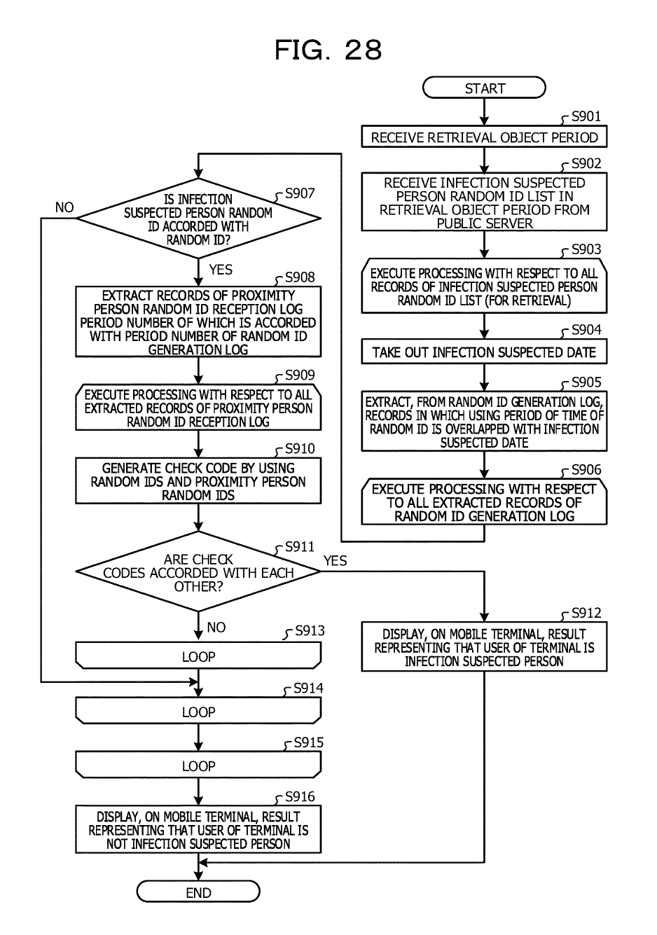

FIG. 28 is a flowchart illustrating a flow of processing of determining suspected infection according to the third embodiment. The processing illustrated in FIG. 28 is different from that of FIG. 24 in that S910 and S911 are executed instead of S707 to S709 illustrated in FIG. 24, compared to FIG. 24. Therefore, only different points will be described.

In S910 of FIG. 28, the determination unit 21 calculates a check code=Hash (a proximity person random ID, a random ID) by using corresponding random IDs and corresponding proximity person random IDs among logs managed in the device thereof.

After that, the determination unit 21 determines whether or not the check code calculated in S910 is accorded with a check code of disclosed infection suspected person information in S911 of FIG. 28. Here, in the case where the check codes are accorded with each other, the determination unit 21 determines that a user of this device is an infection suspected person.

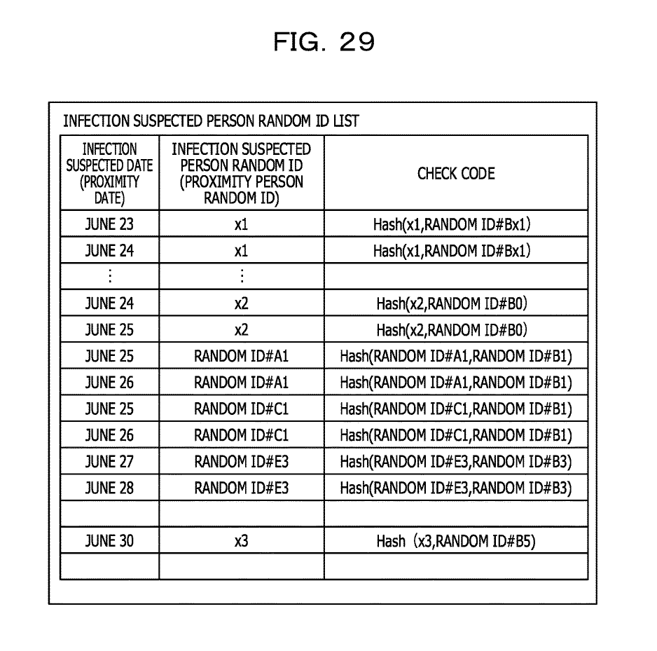

A specific example will now be described by using FIG. 11 and the like of the first embodiment. Determination of an infection suspected person which is distinctive processing of the third embodiment will be described here. Specifically, infection suspected person information disclosed in the period T7 will be illustrated. FIG. 29 illustrates a case where the infection suspected person information of the public server 50 in the period T7 of FIG. 12A is applied to the third embodiment. FIG. 29 is different from FIG. 25 of the second embodiment in that a “check code” is disclosed instead of an “infected person random ID” so as to further enhance confidentiality.

Specifically, the mobile terminal #B refers to the random ID generation log 15 so as to identify period numbers “B1 to B5” corresponding to an infection suspected period (on and after 6/24). Then, the mobile terminal #B refers to the proximity person random ID reception log 16 so as to extract “random ID #A1, random ID #C1, random ID #E3” as proximity person random IDs corresponding to these period numbers.

Further, since the period number of the proximity person random ID “random ID #A1” and the proximity person random ID “random ID #C1” is “B1”, the mobile terminal #B refers to the random ID generation log 15 to identify a used period: from B1 “6/25, 8:00” to B2 “6/26, 8:00”. That is, the mobile terminal #B sets infection suspected dates of the proximity person random ID “random ID #A1” and the proximity person random ID “random ID #C1” as “6/25” and “6/26”. Further, the mobile terminal #B identifies a random ID thereof when the period number is “B1” as “random ID #B1”.

In a similar manner, since the period number of the proximity person random ID “random ID #E3” is “B3”, the mobile terminal #B refers to the random ID generation log 15 to identify a used period: from B3 “6/27, 8:00” to B4 “6/28, 8:00”. That is, the mobile terminal #B sets infection suspected dates of the proximity person random ID “random ID #E3” as “6/27” and “6/28”. Further, the mobile terminal #B identifies the random ID thereof when the period number is “B3” as “random ID #B3”.

After that, the mobile terminal #B calculates a Hash value between the random ID “random ID #B1” thereof when the period number is “B1” and the proximity person random ID “random ID #A1” and a Hash value between the random ID “random ID #B1” thereof when the period number is “B1” and the proximity person random ID “random ID #C1”. Further, the mobile terminal #B calculates a Hash value between the random ID “random ID #B3” thereof when the period number is “B3” and the proximity person random ID “random ID #E3”.

Then, the mobile terminal #B registers the identified proximity person random IDs, the infection suspected dates, and the Hash values in the public server 50. Specifically, as illustrated in FIG. 29, “infection suspected date=6/25, infection suspected person random ID=random ID #A1, check code=Hash (random ID #A1, random ID #B1)” and “infection suspected date=6/26, infection suspected person random ID=random ID #A1, check code=Hash (random ID #A1, random ID #B1)” are registered in the public server 50.

In a similar manner, “infection suspected date=6/25, infection suspected person random ID=random ID #C1, check code=Hash (random ID #C, random ID #B1)” and “infection suspected date=6/26, infection suspected person random ID=random ID #C1, check code=Hash (random ID #C1, random ID #B1)” are registered in the public server 50.

In a similar manner, “infection suspected date=6/27, infection suspected person random ID=random ID #E3, check code=Hash (random ID #E3, random ID #B3)” and “infection suspected date=6/28, infection suspected person random ID=random ID #E3, check code=Hash (random ID #E3, random ID #B3)” are registered in the public server 50.

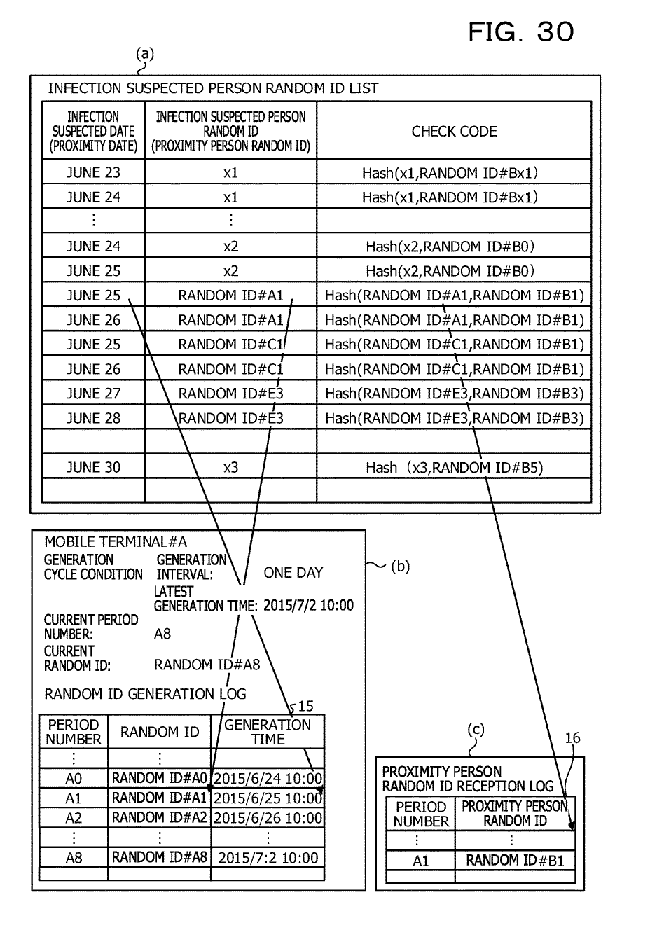

After that, the mobile terminal #A executes infection determination in the period T8. FIG. 30 illustrates a case where the infection determination of the mobile terminal #A in the period T8 of FIG. 12A is applied to the third embodiment. As illustrated in FIG. 30, the mobile terminal #A extracts a random ID thereof “random ID #A1” stored in infection suspected person information (FIG. 30(a)), and an infection suspected date “6/25” and a check code “Hash (random ID #A1, random ID #B1)” which correspond to the “random ID #A1” and are stored in infection suspected person information (FIG. 30(a)).

Subsequently, the mobile terminal #A refers to the random ID generation log 15 thereof (FIG. 26(b)). Then, the mobile terminal #A acquires generation time “2015/6/25, 10:00” which is associated with the random ID “random ID #A1” acquired from the infection suspected person information. Then, the mobile terminal #A determines that the acquired generation time “2015/6/25, 10:00” is included in the infection suspected date.

Further, the mobile terminal #A refers to the random ID generation log 15 thereof (FIG. 30(b)). Then, the mobile terminal #A acquires the period number “A1” which is associated with the random ID “random ID #A1” acquired from the infection suspected person information. The mobile terminal #A refers to the proximity person random ID reception log 16 thereof (FIG. 30(c)). Then, the mobile terminal #A extracts the proximity person random ID “random ID #B1” which is associated with the acquired period number “A1”.

Subsequently, the mobile terminal #A calculates a Hash value by using the random ID #A1 acquired from the infection suspected person information (FIG. 30(a)) and the random ID #B1 acquired from the proximity person random ID reception log 16 thereof (FIG. 30(c)). Since the Hash value to be calculated here is Hash (random ID #A1, random ID #B1) and is accorded with a check code registered in the infection suspected person information, the mobile terminal #A determines that the user #A is an infection suspected person.

Thus, it is possible to identify proximity states among users without disclosing proximity periods of time, random IDs of infected persons, and the like. Accordingly, it is possible to omit disclosure of personal information of users and enhance confidentiality of disclosed information.

Here, as illustrated in FIG. 29, some data in the infection suspected person information are duplicated except for dates. In such case, grouping enables a memory capacity used by the public server 50 to be reduced.

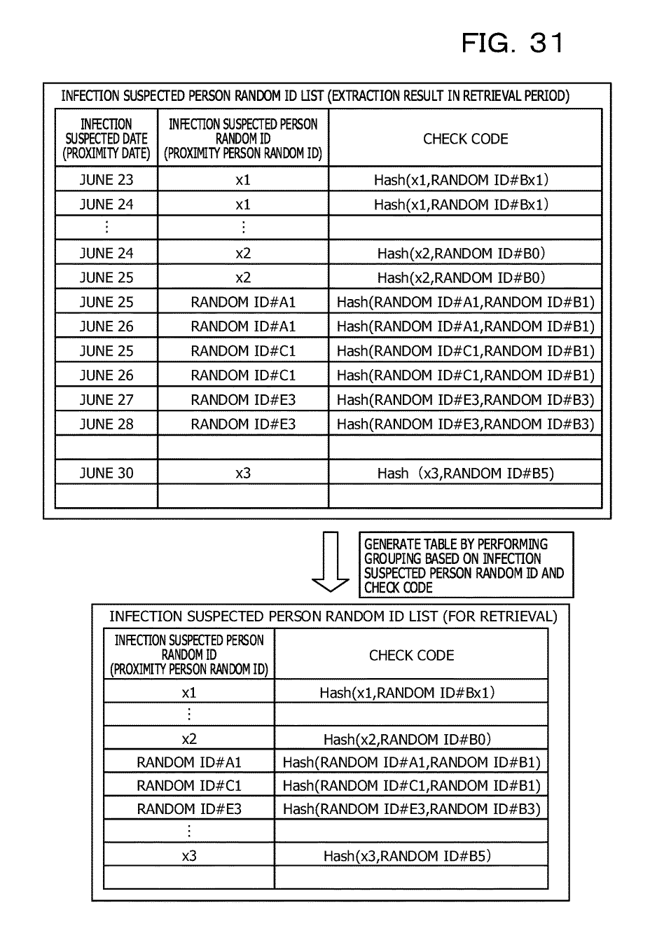

FIG. 31 illustrates an example in which infection suspected person information of the public server 50 in the period T7 of FIG. 12A is subjected to grouping. As illustrated in FIG. 31, after the public server 50 receives infection suspected person information from the mobile terminal #B, the public server 50 executes grouping based on “infection suspected person random IDs” and “check codes”. Then, the public server 50 edits the infection suspected person information.

Specifically, the public server 50 puts “infection suspected date=6/25, infection suspected person random ID=random ID #A1, check code=Hash (random ID #A1, random ID #B1)” and “infection suspected date=6/26, infection suspected person random ID=random ID #A1, check code=Hash (random ID #A1, random ID #B1)” together as “infection suspected person random ID=random ID #A1, check code=Hash (random ID #A1, random ID #B1)”.

In a similar manner, “infection suspected date=6/25, infection suspected person random ID=random ID #C1, check code=Hash (random ID #C1, random ID #B1)” and “infection suspected date=6/26, infection suspected person random ID=random ID #C1, check code=Hash (random ID #C1, random ID #B1)” are put together as “infection suspected person random ID=random ID #C1, check code=Hash (random ID #C1, random ID #B1)” in the public server 50.

In a similar manner, “infection suspected date=6/27, infection suspected person random ID=random ID #E3, check code=Hash (random ID #E3, random ID #B3)” and “infection suspected date=6/28, infection suspected person random ID=random ID #E3, check code=Hash (random ID #E3, random ID #B3)” are put together as “infection suspected person random ID=random ID #E3, check code=Hash (random ID #E3, random ID #B3)” in the public server 50.

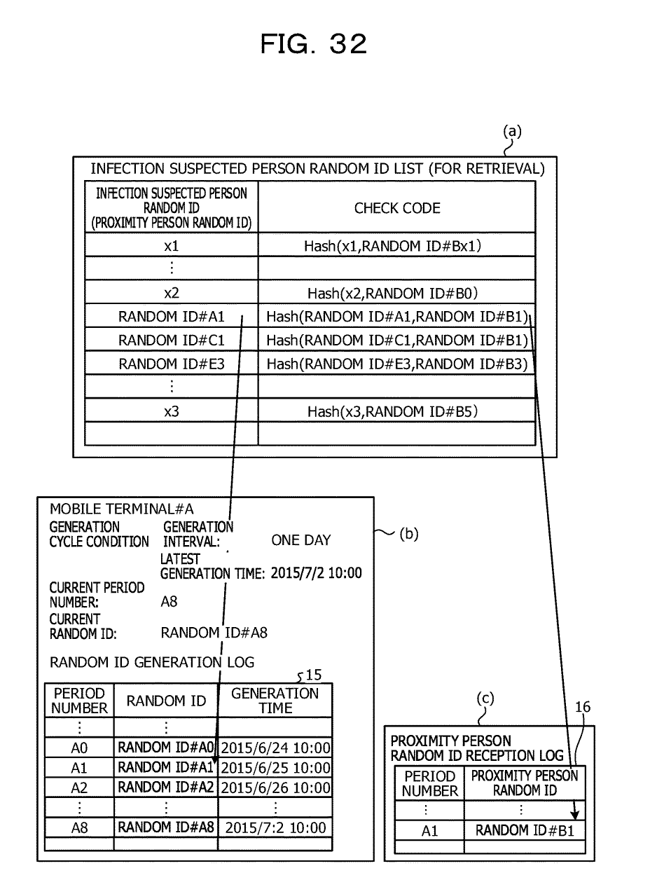

Infection determination will now be described. FIG. 32 illustrates infection determination using grouped infection suspected person information. As illustrated in FIG. 32, the mobile terminal #A extracts the random ID “random ID #A1” thereof stored in the infection suspected person information (FIG. 32(a)) and a check code “Hash (random ID #A1, random ID #B1)” which corresponds to the random ID “random ID #A1” and is stored in the infection suspected person information (FIG. 32(a)).

Subsequently, the mobile terminal #A refers to the random ID generation log 15 thereof (FIG. 32(b)). Then, the mobile terminal #A acquires the period number “A1” which is associated with the random ID “random ID #A1” acquired from the infection suspected person information. The mobile terminal #A refers to the proximity person random ID reception log 16 thereof (FIG. 32(c)). Then, the mobile terminal #A extracts the proximity person random ID “random ID #B1” which is associated with the acquired period number “A1”.

Subsequently, the mobile terminal #A calculates a Hash value by using the random ID #A1 acquired from the infection suspected person information (FIG. 32(a)) and the random ID #B1 acquired from the proximity person random ID reception log 16 thereof (FIG. 32(c)). Since the Hash value to be calculated here is Hash (random ID #A1, random ID #B1) and is accorded with a check code registered in the infection suspected person information, the mobile terminal #A determines that the user #A is an infection suspected person.

Thus, it is possible to reduce the information amount of infection suspected person information and reduce the using amount of a memory. Thus, it is possible to reduce the information amount of infection suspected person information, being able to speed up processing of the infection determination.

### Fourth Embodiment

Each mobile terminal may assign a sequential number (SQN) to a random ID so as to narrow down infection suspected person information and thus shorten time for infection determination. An example in which a SQN is assigned to a random ID will be described in the fourth embodiment.

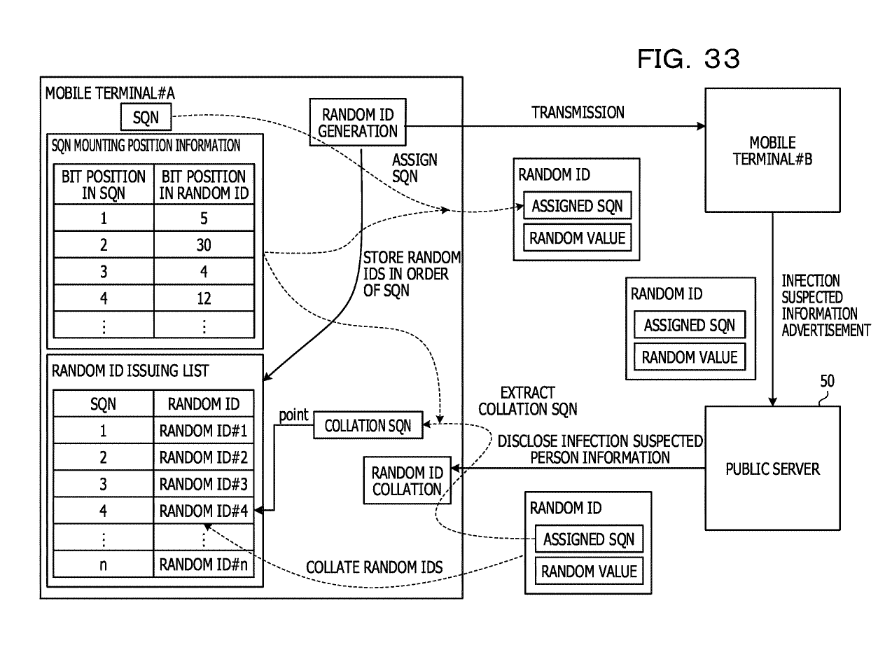

FIG. 33 illustrates an example of assigning a sequential number according to the fourth embodiment. An example in which the mobile terminal #A transmits a random ID to the mobile terminal #B will be described here. As illustrated in FIG. 33, the mobile terminal #A stores SQN mounting position information in which “bit positions in SQN” and “bit positions in random ID” are associated with each other. Here, the “bit position in SQN” is information for identifying an arrangement position in a SQN. The “bit position in random ID” is information for identifying an arrangement position of a SQN in a random ID.

In the case where a SQN is constituted of two bits, the generation unit 18 of the mobile terminal #A refers to the SQN mounting position information. Then, the generation unit 18 generates a random ID in which the first bit in a SQN is assigned to the fifth bit of a random value and the second bit of the SQN is assigned to the 30th bit of the random value.

The mobile terminal #A stores a random ID issuing list in which “SQNs” and “random IDs” are associated with each other. Here, a “SQN” is a sequential number assigned to a random ID. A “random ID” is a random ID in which a SQN is assigned.

In such state, the mobile terminal #A refers to the SQN mounting position information when issuing a random ID. Then, the mobile terminal #A generates and issues a random ID in which a SQN, which is an assignment object, is assigned to a predetermined position of random values. Then, the mobile terminal #A stores the random ID in a manner to associate the random ID in which the SQN is assigned and the assigned SQN (assignment SQN) in the random ID issuing list. The random ID in which the SQN is thus assigned is disclosed in the public server 50 as infection suspected information after being held by the adjacent mobile terminal #B.

After that, when the mobile terminal #A acquires the infection suspected person information from the public server 50, the mobile terminal #A extracts the random ID thereof from the infection suspected person information. Then, the mobile terminal #A reproduces the SQN (assignment SQN) from the extracted random ID. Subsequently, the mobile terminal #A identifies a random ID which corresponds to the reproduced SQN (assignment SQN) from the random ID issuing list. Here, in the case where the random ID extracted from the infection suspected person information is accorded with the random ID identified by using the SQN, the mobile terminal #A determines that the user of the mobile terminal #A is an infection suspected person.

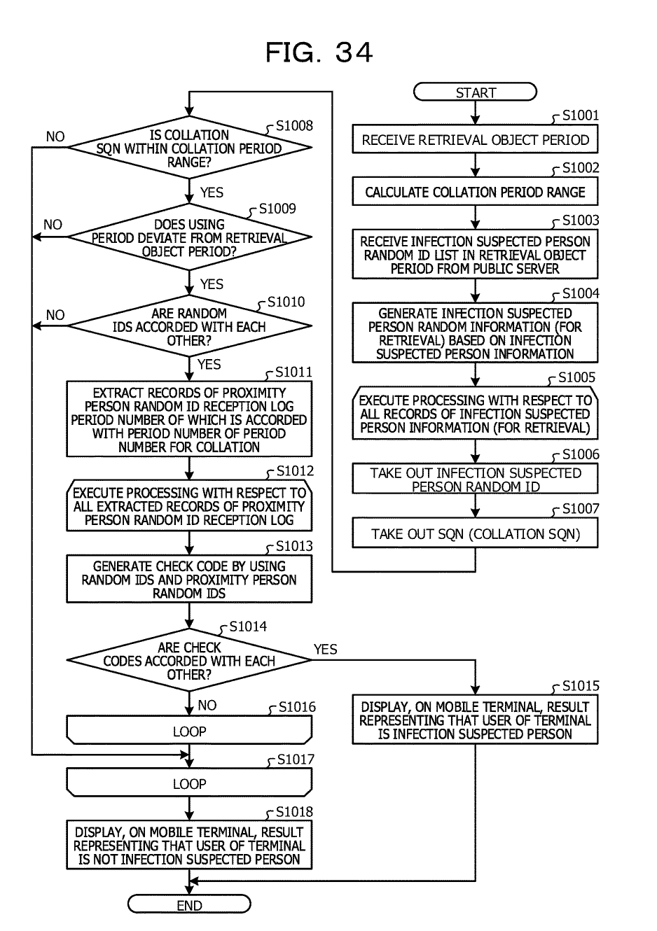

FIG. 34 is a flowchart illustrating a flow of processing of determining suspected infection according to the fourth embodiment. The mobile terminal 10 will be described as an example here. As illustrated in FIG. 34, when the mobile terminal 10 receives a retrieval object period in which infection is suspected (S1001), the mobile terminal 10 calculates a collation period range (S1002). For example, the mobile terminal 10 refers to the random ID generation log 15 so as to identify a random ID which is issued in the retrieval object period. Then, the mobile terminal 10 refers to a random ID issuing list so as to set a range of the SQN assigned in the identified random ID as a collation period range.

Subsequently, the mobile terminal 10 acquires infection suspected person information in the retrieval object period from the public server 50 (S1003). After that, the mobile terminal 10 generates infection suspected person information for retrieval based on the acquired infection suspected person information (S1004). For example, the mobile terminal 10 deletes couples of “infection suspected person random IDs, check codes” which are respectively duplicated from the infection suspected person information to normalize the infection suspected person information.

After that, the mobile terminal 10 executes loop processing from S1005 to S1017 with respect to all records of the infection suspected person information for retrieval. Specifically, the mobile terminal 10 takes out an infection suspected person random ID from the record of the infection suspected person information which is a processing object (S1006). Then, the mobile terminal 10 takes out a SQN (collation SQN) from the infection suspected person random ID in accordance with the SQN mounting position information (S1007).

Subsequently, in the case where the collation SQN which is taken out is not included in the collation period range (S1008: No), the mobile terminal 10 executes processing of S1017 and after with respect to a next infection suspected person random ID.

On the other hand, in the case where the collation SQN which is taken out is included in the collation period range (S1008: Yes), the mobile terminal 10 determines whether or not a using period of the random ID corresponding to the collation SQN is overlapped with the retrieval object period (S1009).

Then, in the case where the using period of the random ID corresponding to the collation SQN is not overlapped with the retrieval object period (S1009: No), the mobile terminal 10 executes the processing of S1017 and after with respect to a next infection suspected person random ID.

On the other hand, in the case where the using period of the random ID corresponding to the collation SQN is overlapped with the retrieval object period (S1009: Yes), the mobile terminal 10 determines whether or not the random ID corresponding to the collation SQN is accorded with the infection suspected person random ID (S1010).

Then, in the case where the random ID corresponding to the collation SQN is not accorded with the infection suspected person random ID (S1010: No), the mobile terminal 10 executes the processing of S1017 and after with respect to a next infection suspected person random ID.

On the other hand, in the case where the random ID corresponding to the collation SQN is accorded with the infection suspected person random ID (S1010: Yes), the mobile terminal 10 executes processing S1011 and after. The processing S1011 and after are similar to processing S908 and after of FIG. 28, so that detailed description will be omitted.

Thus, the mobile terminal 10 is capable of simultaneously issuing a large number of random IDs and narrowing collation objects by SQNs to collate the collation objects when performing collation to check whether or not a received random ID is a random ID issued thereby, being able to reduce collation cost.

### Fifth Embodiment

The embodiments of the present disclosure have been described thus far, but the present disclosure may be embodied as various types of embodiments as well as the embodiment described above.

In the above-described embodiments, the example of the infection determination is described, but application is not limited to this. For example, the present disclosure is applicable to determination of contact with a criminal. For example, it is possible to perform similar processing by replacing a mobile terminal of an infected person with a mobile terminal of a criminal.

Various processing such as issuing of a random ID, registration of infection suspected person information, and infection determination may be executed by any of the devices illustrated in FIG. 1. Processing may be sorted by arbitrary unit, as well. For example, the mobile terminal 10 may perform issuing of a random ID and registration of infection suspected person information and a medical institution terminal of a hospital may perform infection determination and the like.

The example in which each mobile terminal acquires infection suspected person information from the public server 50 to perform suspect determination is described in the above-described embodiments, but the present disclosure is not limited to this. For example, each mobile terminal exchanges identification information with another mobile terminal (short-range communication device) which approaches in a predetermined distance which allows short-range communication with the each mobile terminal. Then, each mobile terminal stores exchange time information, the identification information thereof, and the identification information of the other nearby device in a manner to associate the exchange time information, the identification information thereof, and the identification information of the other nearby device with each other. The identification information here is same as that in the above-described embodiments.

After that, a terminal of an infected person (a short-range communication device) registers, in the public server 50, another device identification information, in which the identification information of the other mobile terminal which is received from the other mobile terminal is accorded with the time information. Then, each mobile terminal receives the other device identification information of the terminal of the infected person from the public server 50. Here, each mobile terminal may access the public server 50 to acquire another device identification information of the terminal of the infected person. Alternatively, the public server 50 may transmit the other device identification information to preliminarily-designated mobile terminals.

Then, each mobile terminal is capable of identifying proximity with the terminal of the infected person based on the received another device identification information and a couple of the stored identification information thereof and the time information. For example, each mobile terminal extracts the time information and the identification information included in the received another device identification information. Then, each mobile terminal may determine that the mobile terminal has approached the terminal of the infected person, in the case where these pieces of information are stored therein. Further, each mobile terminal may determine that the mobile terminal has approached the terminal of the infected person, in the case where there is the identification information thereof corresponding to the extracted time information. That is, in the case where it is possible to specify that each mobile terminal has exchanged identification information with the terminal of the infected person at time identified by time information included in received another device identification information, each mobile terminal determines that the mobile terminal has approached the terminal of the infected person.

Components of each device illustrated in FIG. 3 do not have to be physically configured as illustrated. That is, the components may be configured in a manner to be dispersed or integrated in an arbitrary unit. Further, all or arbitrary part of processing functions performed in each device may be realized by a central processing unit (CPU) and a program analyzed and executed by the CPU, or realized as hardware by a wired logic.

Among the processing described in the embodiments, all or part of the processing which is described as processing automatically performed may be performed manually. Alternatively, all or part of the processing which is described as processing manually performed may be automatically performed by a related art method. In addition, the processing procedure, control procedure, specific names, and information including various data and parameters which are illustrated in the above description and drawings may be arbitrarily changed except for a specially-mentioned case.

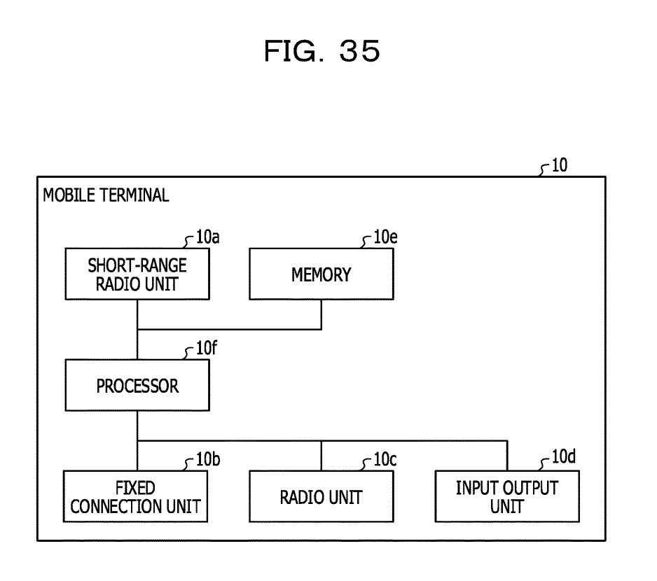

The mobile terminal 10 described above may be realized by a computer having the following hardware configuration, for example. FIG. 35 illustrates a configuration example of hardware of the mobile terminal 10. As illustrated in FIG. 35, the mobile terminal 10 includes a short-range radio unit 10a, a fixed connection unit 10b, a radio unit 10c, an input output unit 10d, a memory 10e, and a processor 10f.

The short-range radio unit 10a is a short-range radio interface which executes NFC and the like. The fixed connection unit 10b is a connection interface such as a USB. The radio unit 10c is a network interface card or the like. The input output unit 10d is a display device such as a display or an input output interface such as a microphone, for example.

The memory 10e is a random access memory (RAM) such as a synchronous dynamic random access memory (SDRAM), a read-only memory (ROM), a flash memory, or the like. The processor 10f is a CPU, a digital signal processor (DSP), a field programmable gate array (FPGA), a programmable logic device (PLD), or the like.

The mobile terminal 10 operates as an information processing device which executes an infection determination method by reading and executing a program. That is, the mobile terminal 10 executes a program for executing functions equivalent to the generation unit 18, the exchange unit 19, the disclosure request unit 20, and the determination unit 21. As a result, the mobile terminal 10 is capable of executing a process for executing functions equivalent to the generation unit 18, the exchange unit 19, the disclosure request unit 20, and the determination unit 21.

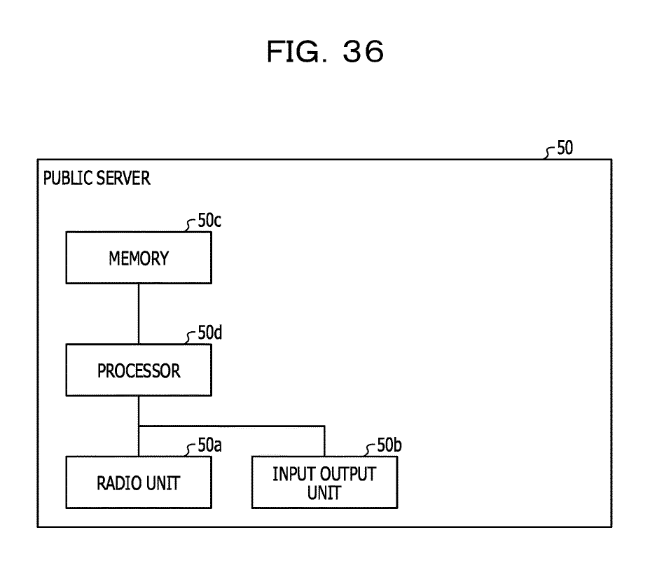

The public server 50 described above may be realized by a computer having the following hardware configuration, for example. FIG. 36 illustrates a configuration example of hardware of the public server 50. As illustrated in FIG. 36, the public server 50 includes a radio unit 50a, an input output unit 50b, a memory 50c, and a processor 50d.

The radio unit 50a is a network interface card or the like. The input output unit 50b is a display device such as a display or an input output interface such as a microphone, for example. Examples of the memory 50c include a RAM such as a SDRAM, a ROM, and a flash memory. Examples of the processor 50d include a CPU, a DSP, a FPGA, and a PLD.

The public server 50 operates as an information processing device which executes an infection determination method by reading and executing a program. That is, the public server 50 executes a program for executing functions equivalent to the reception unit 55 and the disclosure unit 56. As a result, the public server 50 is capable of executing a process for executing functions equivalent to the reception unit 55 and the disclosure unit 56.

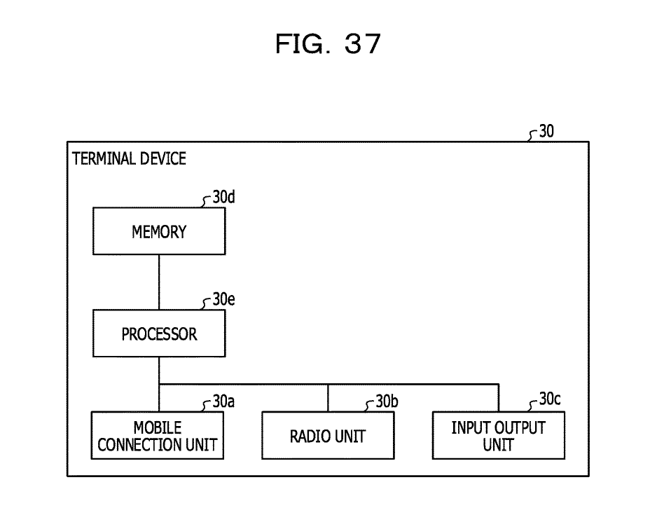

The terminal device 30 described above may be realized by a computer having the following hardware configuration, for example. FIG. 37 illustrates a configuration example of hardware of the terminal device 30. As illustrated in FIG. 37, the terminal device 30 includes a mobile connection unit 30a, a radio unit 30b, an input output unit 30c, a memory 30d, and a processor 30e.

The mobile connection unit 30a is a connection interface such as a USB. The radio unit 30b is a network interface card or the like. The input output unit 30c is a display device such as a display or an input output interface such as a microphone, for example. The memory 30d is a RAM such as a SDRAM, a ROM, a flash memory, or the like, for example. The processor 30e is a CPU, a DSP, a FPGA, a PLD, or the like, for example.

The terminal device 30 operates as an information processing device which executes an infection determination method by reading and executing a program. That is, the terminal device 30 executes a program for executing functions equivalent to the registration unit 34 and the retrieval unit 35. As a result, the terminal device 30 is capable of executing a process for executing functions equivalent to the registration unit 34 and the retrieval unit 35.

Other programs in the embodiments are not limitedly executed by each device and the like. For example, the present disclosure is similarly applicable to a case where other computers or servers executes a program or a case where computers and servers execute the program in cooperation, as well.

This program may be distributed via a network such as the internet. This program may be recorded in a recording medium, which is readable by a computer, such as hard disk, a flexible disk (FD), a CD-ROM, a magneto-optical disk (MO), and a digital versatile disc (DVD), and be read from the recording medium by the computer so as to be executed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method executed by a system including a plurality of communication devices and a server, the communication method comprising:
storing, by a communication device of the plurality of communication devices, generation log information in which a period of time and an identifier varying depending on time are associated with each other for each of a plurality of periods of time;
when another communication device among the plurality of communication devices is detected, transmitting, to the another communication device, a combination of a time at which the another communication device is detected and an identifier of the communication device extracted from the generation log information, the identifier corresponding to a time at which the another communication device is detected;
when information that includes a combination of a time at which the communication device is detected and an identifier of the another communication device, is received from the another communication device, storing the received information as reception log information;
determining whether an identifier related to the communication device is included in the reception log information stored in a target communication device, when the reception log information, which is stored in the target communication device among the plurality of communication devices, is received from the server; and
identifying the communication device as a device related to the target communication device when it is determined that the identifier related to the communication device is included in the reception log information.

2. The communication method according to claim 1, further comprising:
transmitting, by the server, a request of the reception log information, the reception log information being stored in the target communication device, to the target communication device when a notification representing that a user of the target communication device is infected is received; and
receiving the reception log information that is transmitted from the target communication device in response to the request and is stored in the target communication device.

3. The communication method according to claim 2,
wherein the determining includes receiving, from the server, the reception log information stored in the target communication device by accessing the server.

4. The communication method according to claim 2,
wherein the identifying includes identifying a user of the communication device as an infection suspected person when it is determined that the identifier related to the communication device is included in the reception log information stored in the target communication device.

5. The communication method according to claim 2, further comprising:
generating, by the server, infection suspected person information, in which an identifier related to the infection suspected person and a period of time in which infection is suspected are associated with each other, based on the reception log information stored in the target communication device;
wherein the determining includes determining whether the identifier related to the communication device is included in the infection suspected person information.

6. The communication method according to claim 5,
wherein the identifier related to the infection suspected person is a code generated by using an identifier related to a communication device of the infection suspected person and an identifier related to the target communication device.

7. The communication method according to claim 6,
wherein the code is a hash value calculated by using an identifier related to a communication device of the infection suspected person and an identifier related to the target communication device.

8. The communication method according to claim 1, wherein in the storing includes:
determining whether the received information is included in the reception log information in a memory, and
storing the received information in the memory when it is determined that the received information is not included in the reception log information.

9. The communication method according to claim 1,
wherein a generation method of the identifier varies depending on each of the plurality of communication devices.

10. A system comprising:
a plurality of communication devices; and
a server,
wherein each of the plurality of communication devices is configured to:
store, by a processor included in a communication device of the plurality of communication devices, generation log information in which a period of time and an identifier varying depending on time are associated with each other for each of a plurality of periods of time;
when another communication device among the plurality of communication devices is detected, transmit, to the another communication device, a combination of a time at which the another communication device is detected and an identifier of the communication device extracted from the generation log information, the identifier corresponding to a time at which the another communication device is detected;
when information that includes a combination of a time at which the communication device is detected and an identifier of the another communication device, is received from the another communication device, store the received information as reception log information;
determine whether an identifier related to the communication device is included in the reception log information, the reception log information being stored in a target communication device, when the reception log information, which is stored in the target communication device among the plurality of communication devices, is received from the server; and
identify the communication device as a device related to the target communication device when it is determined that the identifier related to the communication device is included in the reception log information.

11. A non-transitory computer-readable recording medium storing a program that causes a communication device included in a plurality of communication devices to execute a process, the communication device storing generation log information in which a period of time and an identifier varying depending on time are associated with each other for each of a plurality of periods of time, the process comprising:
when another communication device among the plurality of communication devices is detected, transmitting, to the another communication device, a combination of a time at which the another communication device is detected and an identifier of the communication device extracted from the generation log information, the identifier corresponding to a time at which the another communication device is detected;
when information that includes a combination of a time at which the communication device is detected and an identifier of the another communication device, is received from the another communication device, storing the received information as reception log information;
determining whether an identifier related to the communication device is included in the reception log information stored in a target communication device, when the reception log information, which is stored in the target communication device among the plurality of communication devices, is received from the server; and
identifying the communication device as a device related to the target communication device when it is determined that the identifier related to the communication device is included in the reception log information.
